(19) United States
(12) Patent Application Publication
(10) Pub. No.: US 2023/0381739 A1
(43) Pub. Date: Nov. 30, 2023

(54) POLAR LIQUIDS WITH HIGH POROSITY AND USES THEREOF

(71) Applicant: President and Fellows of Harvard College, Cambridge, MA (US)

(72) Inventors: Jarad A. MASON, Cambridge, MA (US); Malia B. WENNY, Cambridge, MA (US); Daniel P. ERDOSY, Cambridge, MA (US); Joy CHO, Cambridge, MA (US); Christopher DELRE, Cambridge, MA (US)

(73) Assignee: President and Fellows of Harvard College, Cambridge, MA (US)

(21) Appl. No.: 18/030,858

(22) PCT Filed: Oct. 8, 2021
(86) PCT No.: PCT/US2021/054267

§ 371 Date: Apr. 7, 2023

Related U.S. Application Data
(60) Provisional application No. 63/089,242, filed on Oct. 8, 2020.

(51) Int. Cl. B01J 20/22; B01J 20/28; B01J 20/18; B01J 20/32

(52) U.S. Cl. CPC B01J 20/226; B01J 20/28007; B01J 20/186; B01J 20/3204; B01J 20/3217; B01J 20/3274

(57) ABSTRACT

To increase the gas solubility of polar liquids, the invention leverages coordination chemistry, nanoscience, and porous materials design to create porous liquids, e.g., aqueous solutions, containing a high density of networks of dry pores—which will feature dramatically higher capacities for dissolved gases than conventional polar liquids.

### BACKGROUND OF THE INVENTION

The efficient transport of gas molecules through a liquid is critical to many biomedical and energy-related technologies, but the low solubility of gases in most liquids, in particular polar liquids, imposes fundamental thermodynamic and kinetic limitations that are difficult to overcome with conventional solvents. Liquids with higher gas solubilities are needed, for instance, to support next-generation fuel cells and electrocatalysts, to create viable artificial blood substitutes, and to supply O₂ during trauma treatment, organ preservation, eye surgery, wound healing, tissue engineering, and cell culture. Many of these applications require the primary component of the liquid to be water, for which strong hydrogen bonding interactions and a low density of transient free volume leads to extremely low gas solubilities. Accordingly, there is a need for increasing the gas solubility of polar liquids.

### SUMMARY OF THE INVENTION

To increase the gas solubility of polar liquids, the invention leverages thermodynamics, nanoscience, and porous materials design to create porous polar liquids, e.g., aqueous solutions, containing a high density of networks of dry, nanosized cavities—which will feature dramatically higher capacities for dissolved gases than conventional liquids.

This invention provides a new phase space of porous liquids that exhibit both fundamentally insightful and technologically important properties. In particular, porous water can create new opportunities for applications in energy, catalysis, and health, including 1) solvents for selective catalytic oxidation reactions, 2) electrolytes for efficient fuel cells, e.g., to power green vehicles, 3) a new generation of artificial blood substitutes, and 4) sources of injectable O₂, e.g., for treating patients suffering from trauma, stroke, and cardiac arrest.

An aspect of the invention provides a liquid composition including a polar liquid and a dispersion of porous particles, the pores of which include an internal surface that resists wetting by the polar liquid and an external surface that is wettable by the liquid. The pores are sized to allow entry of a gas and molecules of the polar liquid.

In some embodiments, the polar liquid is a polar solvent, e.g., a polar protic solvent such as water or an alcohol, such as methanol, ethanol, isopropanol, or propan-1-ol. In some embodiments, the internal surface is hydrophobic. In some embodiments, the porous particles include a zeolite or metal-organic framework (MOF). In some embodiments, the zeolite includes silicalite-1, ZSM-5, or zeolite LTL; or the MOF includes ZIF-8 or ZIF-67. In some embodiments, the particles are nanoparticles or microparticles. In some embodiments, the particles are crystalline.

In some embodiments, the particles include a hydrophilic coating, e.g., that does not penetrate into the pores. In some embodiments, the particles include a globular protein (e.g., an albumin, e.g., bovine serum albumin (BSA), ovalbumin, lactalbumin, or human serum albumin (HSA)). In some embodiments, the particles include a covalently or non-covalently attached hydrophilic organic polymer coating. In some embodiments, the hydrophilic organic polymer coating is covalently attached to the particles, e.g., by β-hydroxyalkyl covalent linkages.

In some embodiments, the gas is dissolved in the composition and located in the pores of the porous particles. Exemplary gases include argon, oxygen, nitrogen, carbon dioxide, carbon monoxide, xenon, methane, helium, neon, or hydrogen. In some embodiments, the pores resist ingress of the polar liquid below an applied pressure of about 100 bar, about 200 bar, or about 900 bar at room temperature.

In another aspect, the invention provides a composition including a plurality of porous particles, the pores of which include an internal surface that resists wetting by a polar liquid and an external surface that is wettable by the polar liquid. The pores are sized to allow entry of a gas and molecules of the polar liquid.

In some embodiments, the porous particles include a zeolite or metal-organic framework. In some embodiments, the zeolite includes silicalite-1 or ZSM-5 or zeolite LTL; or the MOF includes ZIF-8 or ZIF-67. In some embodiments, the particles are nanoparticles or microparticles. In some embodiments, the particles are crystalline.

In some embodiments, the particles include a hydrophilic coating, e.g., that does not penetrate into the pores. In some embodiments, the particles include a globular protein (e.g., an albumin, e.g., bovine serum albumin (BSA), ovalbumin, lactalbumin, or human serum albumin (HSA)). In some embodiments, the particles include a covalently or non-covalently attached hydrophilic organic polymer coating. In some embodiments, the hydrophilic organic polymer coating is covalently attached to the particles, e.g., by β-hydroxyalkyl covalent linkages.

Another aspect of the invention provides a method of storing a gas in a polar liquid by providing a dispersion of porous particles in the polar liquid. The pores of the particles include an internal surface that resists wetting by the polar liquid and an external surface that is wettable by the polar liquid, and the pores are sized to allow entry of the gas and molecules of the polar liquid. The method further includes dissolving the gas in the dispersion, where the gas is stored in the pores.

In some embodiments, the polar liquid is a polar solvent, e.g., a polar protic solvent such as water or an alcohol such as methanol, ethanol, isopropanol, or propan-1-ol. In some embodiments, the internal surface is hydrophobic. In some embodiments, the gas includes argon, oxygen, nitrogen, carbon dioxide, carbon monoxide, xenon, methane, helium, neon, or hydrogen. In some embodiments, the method further includes allowing the porous particles to disintegrate to release the gas from the dispersion.

Another aspect of the invention provides a method of introducing a gas into a biological system. The method includes providing a dispersion of porous particles in a polar liquid, where the pores of the particles include an internal surface that resists wetting by the polar liquid and an external surface that is wettable by the liquid, where the pores are sized to allow entry of the gas and molecules of the polar liquid, and the gas is stored in the pores. The method further includes contacting the dispersion with the biological system.

An aspect of the invention provides a method of increasing the volumetric mass transfer of a gas to a substrate. The method includes providing a dispersion of porous particles in a liquid, where the pores of the particles include an internal surface that resists wetting by the liquid and an external surface that is wettable by the liquid, where the pores are sized to allow entry of the gas and molecules of the liquid, and where the gas is stored in the pores. The method further includes contacting the dispersion with the substrate and allowing the gas to react therewith.

In any embodiment of the invention, the gas may be a mixture of gases (e.g., oxygen and helium). In any embodiment of the invention, the polar liquid may be a mixture of liquids (e.g., a mixture of polar liquids or a mixture containing a polar liquid and non-polar liquids). Mixtures of compositions of the invention are also contemplated.

By “about” is meant±10% of the specific value.

By “microporous” is meant have a width not exceeding about 2 nm.

### BRIEF DESCRIPTION OF THE DRAWINGS

FIG. 1. Structure and chemical composition of metal organic framework (MOF) nanoparticles utilized in certain embodiments of the invention. The illustrated zeolitic imidazolate frameworks (ZIFs) have high pore volumes and hydrophobicity. ZIF-8 has zinc metal nodes coordinated by 2-methylimidazole linkers, while ZIF-67 has cobalt metal nodes with identical organic linkers.

FIGS. 2a-2b. A schematic depicting two different covalent functionalization approaches for ZIF nanoparticles (a) and the initial target ligands (b). Carbene derivatives and diazonium mediated PEG-grafting are reported to bond strongly on open metal sites without altering the original organic linker, while the imidazole-based Schiff bases proceed by linker exchange.

FIGS. 3a-3b. Results for surface functionalization of ZIF-8 via diazonium mediated PEG grafting (a) and that of ZIF-67 with imidazole-based Schiff base formation (b). ZIF-8 functionalization showed prolonged stability and dispersibility. On the other hand, the ZIF-67 sample showed dispersibility but was slowly hydrolyzed due to its open metal sites over the course of a few days. The preliminary results show that one can achieve controlled release of adsorbed gas over a desired time period through modulating the functionalization ligand.

FIGS. 4a-4g. Creating aqueous fluids with permanent porosity. (a) Illustration of the thermodynamic approach to designing porous water, whereby porous nanocrystals with hydrophobic internal surfaces and hydrophilic external surfaces form stable, uniform dispersions in water that contain permanently dry pores capable of adsorbing gas molecules. (b) The O₂ and CO₂ sorption capacities of two hydrophobic zeolitic imidazolate frameworks (ZIF-8 and ZIF-67) and one hydrophobic zeolite (silicalite-1) are compared to those of pure H₂O, a representative perfluorocarbon solvent (C₇F₁₆), and the density of the bulk gas phase. All O₂ and CO₂ densities are at 1 bar and 25° C. and include the volume occupied by the solid adsorbent or liquid solvent. (c) Crystal structure of silicalite-1 highlighting its external surface that is terminated by surface silanol groups and is intrinsically hydrophilic. Vertices of tetrahedra and spheres represent Si and O atoms, respectively. (d) Crystal structure of ZIF-8 and an illustration of strategies to increase the hydrophilicity of its external surface through covalent functionalization via reaction with hydrophilic epoxides and non-covalent functionalization via the adsorption of the protein bovine serum albumin (BSA). Dark yellow tetrahedra, grey spheres, and blue spheres represent Zn, C, and N atoms, respectively; H atoms are omitted for clarity. (e-g) Dynamic light scattering (DLS) particle size distributions for diluted aqueous solutions of (e) silicalite-1, (f) (mPEG)ZIF-8, and (g) BSA/ZIF-67. The insets show photos of solutions at nanocrystal concentrations of 12 vol %, 4 vol %, and 3 vol %, respectively.

FIGS. 5a-5b. Density measurements to evaluate the porosity of aqueous solutions. The density of a porous solution with dry pores will be lower than the density of an analogous nonporous solution with solvent-filled pores. The measured densities (circles) of several porous nanocrystal dispersions are plotted as a function of nanocrystal concentration at 25° C. Theoretical densities as a function of nanocrystal concentration are indicated by shading, with grey corresponding to a solution with completely dry pores and blue or purple corresponding to a solution with pores filled with aqueous solution or ethanol (EtOH), respectively, at the same density as the bulk solvent. (a) The densities of dispersions of silicalite-1, BSA/ZIF-67, and (mPEG)ZIF-8 nanocrystals in water are consistent with porous solutions containing dry pores. (b) In contrast, the densities of dispersions of silicalite-1 nanocrystals in EtOH and zeolite LTL (Linde Type L) and PEG/ZIF-8 nanocrystals in water are consistent with solutions that have no accessible porosity. Note that the density of nanoconfined solvent is often lower than the bulk solvent density.

FIGS. 6a-6c Equilibrium gas absorption isotherms of aqueous solutions. Gas absorption isotherms for (a) O₂ and (b) CO₂ in a 12 vol % solution of silicalite-1 nanocrystals in water and a 5.1 vol % of zeolite LTL in water at 25° C. Lines represent linear fits to the isotherm data, with the exception of a single-site Langmuir fit for CO₂ absorption in the silicalite-1 solution. The O₂ and CO₂ solubilities of pure water at 25° C. are indicated with lines. (c) The amount of O₂ and CO₂ absorbed by the zeolite nanocrystals in aqueous solution relative to the zeolite solid-state gas capacities (see FIGS. 11a, 11b, 23a, 23b, and Table 6), which is obtained by accounting for the pure water gas solubility. Error bars represent the standard deviations associated with pure water control experiments (Table 9).

FIGS. 7a-7d. (a) O₂ release kinetics for injections of oxygenated silicalite-1, (mPEG)ZIF-8, and BSA/ZIF-67 nanocrystal solutions into deoxygenated water. All solutions were injected into a 1.2-mL gas-tight vial, and the injection volumes are indicated next to the arrows. (b) The amount of O₂ delivered by oxygenated aqueous solutions of hydrophobic zeolite and MOF nanocrystals relative to the theoretical amount calculated by assuming fully dry pores with gas capacities equivalent to those measured in the solid state. (c) Comparison of the O₂ carrying capacities of aqueous solutions of hydrophobic zeolite and MOF nanocrystals to the O₂ carrying capacities of blood (15 g Hb/dL) and two representative perfluorocarbon emulsions (Fluosol and Oxygent). All capacities are for solutions equilibrated at 1 bar O₂ near ambient temperature. (d) The amount of O₂ delivered to deoxygenated packed red blood cells (RBCs) by oxygenated solutions of (mPEG)ZIF-8 (6.7 vol %) and silicalite-1 nanocrystals (9.1 vol % and 10.8 vol % for 60 and 90 nm nanocrystals, respectively) as a function of the volume of solution injected. The O₂ capacities of each solution are calculated from the slope of linear fits to the data. Note that all solutions were equilibrated at 1 bar O₂ at ambient temperature and contain 5% dextrose. Inset: representative O₂ release kinetics for a single injection of 100 pL solution of 60-nm silicalite-1 nanocrystals. The arrow indicates the approximate timepoint of the injection.

FIGS. 8a-8u Density measurements. Solution density (black circles) as a function of concentration and temperature for (a-c) colloidal solutions of 90-nm silicalite-1 nanocrystals in water, (d-f) a colloidal solution of silicalite-1 nanocrystals with 5 wt % dextrose in water, (g-i) colloidal solutions of 90-nm silicalite-1 nanocrystals in ethanol, (j-l) colloidal solutions of zeolite LTL nanocrystals in water, (m-o) colloidal solutions of (mPEG)ZIF-8 nanocrystals in water, (p-r) a colloidal solution of (mPEG)ZIF-8 with 5 wt % dextrose in water, and (s-u) colloidal solutions of ZSM-5 nanocrystals (Si/Al=64) in water. A gradient shows the possible range of theoretical densities for different degrees of pore filling, from air-filled to solvent-filled pores. Note that the maximum pore filling density corresponds to the bulk solvent density, but the density of nanoconfined solvent is often lower than the bulk solvent density.

FIG. 9 Viscosity measurements. The viscosity of colloidal solutions of 90-nm silicalite-1 nanocrystals in water at 25° C. as a function of concentration.

FIGS. 10a-10c Surface area and pore volume measurements. (a) 77 K N₂ adsorption (closed circles) and desorption (open circles) isotherms for ZIF-67, ZIF-8, zeolite LTL, and silicalite-1 before functionalization (if applicable) and dispersion in water. Calculated BET surface areas and pore volumes are listed in Table 4.

(b) 77 K N₂ adsorption isotherms for 60-nm silicalite-1 and ZSM-5 nanocrystals before dispersion in water. The pore volume of 60-nm silicalite-1 calculated by the t-plot method (fit range 3.5 to 9.8 Å) is 0.16 mL/g, which is consistent with the pore volume of 90-nm silicalite-1 (FIG. 16). The pore volume calculated by the t-plot method (fit range (4.7 to 13 Å) of ZSM-5 is 0.17 mL/g, which is also consistent with silicalite-1 nanocrystals. (c) 77 K N₂ adsorption (closed circles) and desorption (open circles) isotherms for ZIF-8 nanocrystals before and after functionalization with mPEG, showing that covalent functionalization has minimal impact on the accessible surface area.

FIGS. 11a-11d Solid-state isotherms. O₂ adsorption isotherms at (a, b) 25° C. and (c, d) 37° C. in the solid state are plotted on a gravimetric and volumetric basis. Volumetric values are calculated from gravimetric values using the crystallographic density. Consistent with the accessible surface area, covalent functionalization of ZIF-8 has a negligible impact on adsorption of O₂ as demonstrated by comparing the adsorption for ZIF-8 and (mPEG)ZIF-8.

FIGS. 12a-12g External surface area in the solid state. Analysis of external surface area by the t-plot method using the Harkins and Jura thickness curve for (a) 90-nm silicalite-1 nanocrystals, (b) ZIF-8 nanocrystals, (c) (mPEG)ZIF-8, and (d) ZIF-67. Solid-state adsorption isotherms for 90 nm silicalite-1 nanocrystals before and after calcination, demonstrating the lack of accessible porosity in non-calcined samples and the contribution of external surface area to adsorption in calcined silicalite-1. (e) t-plot analysis indicating that the total surface area of non-calcined silicalite-1 is consistent with the external surface area of calcined silicalite-1 (Table 4). Adsorption isotherms for (f) O₂ and (g) CO₂ are compared for calcined and non-calcined silicalite-1 nanocrystals at 25° C.

FIG. 13 Cycling data. O₂ capacity of a 9.7 vol % colloidal solution of 90-nm silicalite-1 nanocrystals at 0.2 bar and 15° C. over 3 sorption-desorption cycles. One cycle consists of dosing O₂ to the solution, waiting for equilibration, and then degassing the solution.

FIGS. 14a-14c Absorption equilibration. Raw pressure vs. time data (black circles) for volumetric O₂ absorption experiments at 25° C. in a colloidal solution of 90-nm silicalite-1 nanocrystals in water (12.0 vol%). Three successive doses to the sample without intermediate degassing are shown in order of occurrence from (a) to (c). For each plot, the red line corresponds to a pseudo-first order fit (Eqn 4), and the fitted equilibrium pressure is indicated with a dashed black line.

FIGS. 15a-15e Colloidal stability. DLS measurements of colloidal solutions of (a) silicalite-1 nanocrystals, (b) (mPEG)ZIF-8 nanocrystals, and (c) ZSM-5 nanocrystals at ambient temperature are shown directly after the nanocrystals were dispersed (t=0) and after waiting for the specified amount of time. For silicalite-1 and ZSM-5, the starting dispersions were at concentrations of 12 and 37 vol %, respectively, and were then diluted 100-fold and 250-fold, respectively. Dilution was required to get accurate particle size distributions for high-concentration samples. For (mPEG)ZIF-8, the starting solution was at a concentration of 7 wt %, which was diluted to 2 wt % immediately prior to measurement. Inset images are of aqueous dispersions of (a) 90-nm silicalite-1 (12 vol %) after 2 months, (b) (mPEG)ZIF-8 (4 vol %) after 7 weeks, and (c) high-concentration ZSM-5 nanocrystals (39 vol %) after 1 week. (d, e) Images of pure ZIF-67 (4.0 vol%), PEG/ZIF-67 (3.6 vol% ZIF-67), and PEG/ZIF-67 (3.6 wt % ZIF67) (d) immediately after dispersing in water and (e) after 7 days. As evidenced by the color change to dark red, pure ZIF-67 is prone to hydrolytic degradation, but degradation is inhibited by noncovalent functionalization with BSA or PEG.

FIGS. 16a-16h SEM Images. Representative scanning electron microscopy (SEM) images of nanocrystals used to form colloidal solutions in water: (a) silicalite-1 (average diameter=59±8 nm), (b) silicalite-1 (average diameter=90±16 nm), (c) zeolite LTL, (d) ZSM-5 (average diameter=238±23 nm), (e) as-synthesized ZIF-8 nanocrystals (average diameter=103±10 nm), (f) (mPEG)ZIF-8 nanocrystals that had been dispersed in water for one week (average diameter=98±7 nm), (g) BSA/ZIF-67 (average diameter=844±103 nm) and (h) PEG/ZIF-67 aqueous solutions (average diameter=941±147 nm).

FIG. 17 Summary of O₂ carrying capacities. Amount of O₂ stored in nanocrystal solutions determined by measurement of the amount of O₂ released upon injection of an oxygenated solution into deoxygenated water, along with the percentage of the experimental amount of O₂ released relative to the theoretical amount for a porous solution based on solid-state O₂ adsorption data. At least three measurements were made for each material to obtain an average value and standard deviation. Note that all solutions were equilibrated with 1 bar of O₂ at ambient temperature, except for PEG/ZIF-8 and PEG/ZIF-67 which were equilibrated with air (0.2 bar O₂).

FIGS. 18a-18f Ambient temperature powder X-ray diffraction patterns of dried aqueous solutions of (a) silicalite-1 (90-nm nanocrystals, 12.0 vol %), (b) silicalite-1 (60-nm nanocrystals, 10.0 vol %), (c) zeolite LTL (9.0 vol %), (d) PEG/ZIF-67 (3.4 vol %), (e) BSA/ZIF-67 (3.4 vol %), and (f) (mPEG)ZIF-8 (7 vol %). In each panel, the bottom curve represents the calculated diffraction pattern while the top curve represents the experimental diffraction pattern.

FIG. 19 Ambient temperature powder X-ray diffraction pattern of a dried aqueous solution of ZSM-5 nanocrystals (37.5 vol %). The bottom curve represents the calculated diffraction pattern while the top curve represents the experimental diffraction pattern.

FIGS. 20a-20b (a) O₂ and (b) CO₂ adsorption at 25° C. for 90-nm and 60-nm silicalite-1 nanocrystals, indicating that particle size has a negligible effect on adsorption capacity.

FIGS. 21a-21b Solid-state O₂ adsorption isotherms at 15° C. on a (a) gravimetric (mmol O₂/g solid) and (b) volumetric (mmol O₂/L solid) basis. Volumetric values are calculated from gravimetric values using the crystallographic density of the solid.

FIGS. 22a-22b Solid-state N₂ adsorption isotherms at 25° C. on a (a) gravimetric (mmol N₂/g solid) and (b) volumetric (mmol N₂/L solid) basis. Volumetric values are calculated from gravimetric values using the crystallographic density of the solid.

FIGS. 23a-23b Solid-state CO₂ adsorption isotherms at 25° C. on a (a) gravimetric (mmol CO₂/g solid) and (b) volumetric (mmol CO₂/L solid) basis. Volumetric values are calculated from gravimetric values using the crystallographic density of the solid.

FIGS. 24a-24c Solid-state adsorption isotherms for ZIF-8 nanocrystals before and after functionalization with mPEG, showing that covalent functionalization has a negligible impact on the adsorption of O₂ and N₂ near ambient temperature. Isotherms are shown for (a) O₂ at 15° C., (b) O₂ at 37° C., (c) N₂ at 25° C. Volumetric values are calculated from gravimetric values using the crystallographic density of ZIF-8, since external surface functionalization with mPEG is assumed to have a negligible effect on the crystallographic density.

FIGS. 25a-25b DLS measurements of colloidal solutions of (a) PEG/ZIF-8 and (b) PEG/ZIF-67 in water. The starting solutions contained 30 wt % PEG and 20 wt % ZIF-8 or 7 wt % ZIF-67. Each sample was diluted 100-fold immediately prior to measurement in order to obtain accurate DLS data.

FIG. 26 ¹H-NMR (400 MHz, DMSO-d₆) of mPEG/ZIF-8 nanocrystals digested with a 35 wt % DCI solution in D₂O. δ=7.67 (d, 2H), 3.55-3.35 (m), 3.23 (s, 3H) for mPEG-mIm, and δ=7.52 (s, 2H), 2.56 (s, 3H) for mIm. Note that some mPEG protons could not be accurately quantified due to signal overlap with solvent and low signal-to-noise ratio.

FIG. 27 ESI-MS spectrum of mPEG/ZIF-8 nanocrystals after digestion with 1M HCl that was added to be approximately 1 wt % of the sample solution. Mass calculated for [M+nH]⁺ (bottom) and mass found (top).

### DETAILED DESCRIPTION OF THE INVENTION

The invention provides compositions and methods for storing gases in liquids. Liquids (e.g., water) with permanent porosity can store, transport, and deliver high densities of gas molecules within liquid, e.g., aqueous, environments.

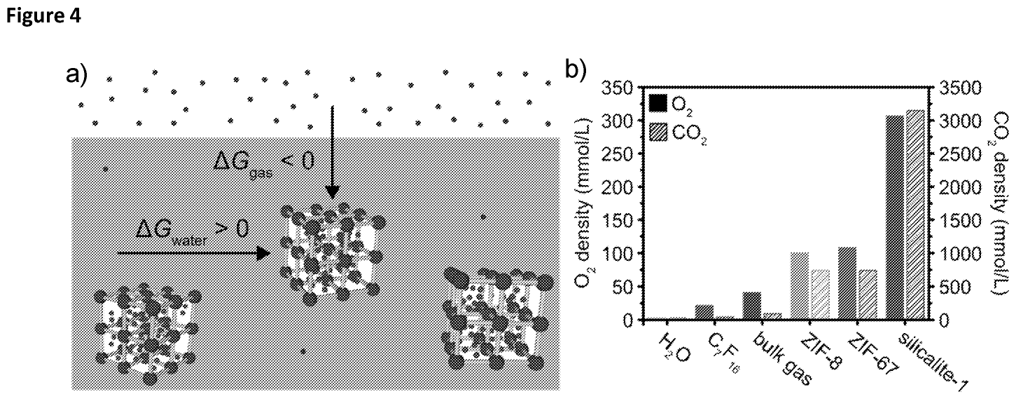

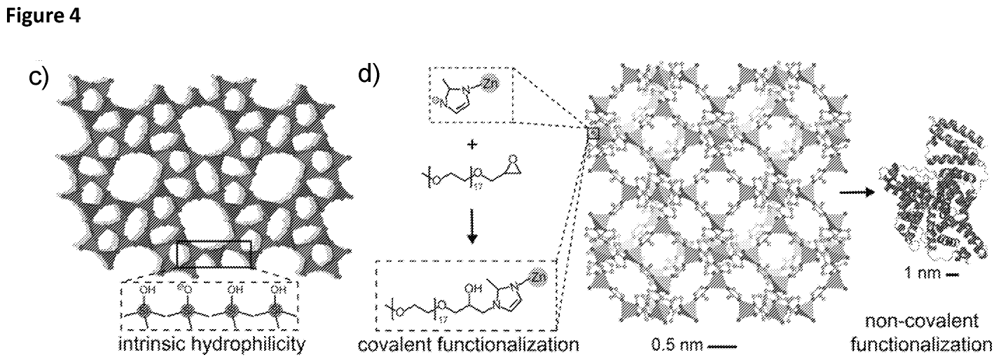

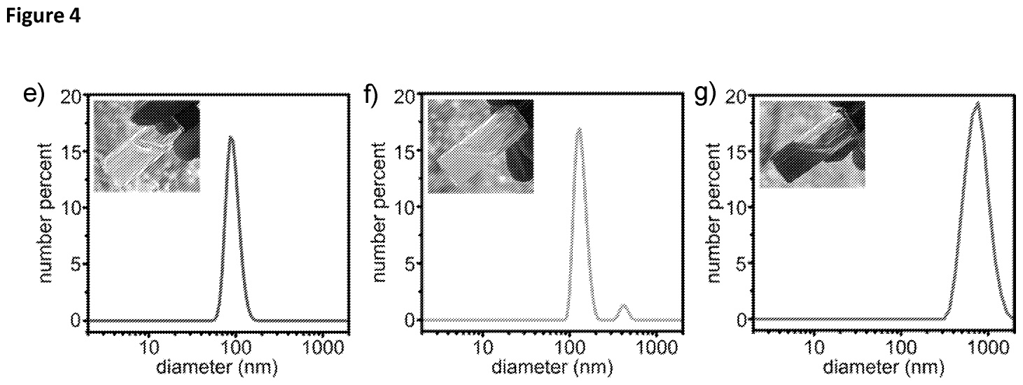

Since dissolving a gas inside a liquid requires overcoming an energy barrier associated with the creation of sufficient space—or porosity—to accommodate the incoming gas molecules, liquids with intrinsic porosity can, in principle, alter the fundamental thermodynamics of gas absorption within a liquid. Specifically, empty pores may substantially reduce—or even eliminate—enthalpic and entropic penalties for solvent rearrangement during gas absorption while simultaneously generating new attractive interactions (FIG. 4a). Embodiments of the invention use the combined effect to achieve a dramatic increase in the density of gas molecules present within solutions, with gas solubility increasing as the density of empty pores increases.

The invention is based on the discovery that liquids with permanent porosity (e.g., microporosity, e.g., including microporous particles) can absorb larger quantities of gas molecules than conventional solvents, providing new opportunities for liquid-phase gas storage, transport, and reactivity. Approaches to designing porous liquids which rely on sterically bulky solvent molecules or surface ligands, may not, however, be amenable to many important solvents, including water. The invention provides a generalizable thermodynamic strategy to create permanent porosity in liquid water. For example, the external and internal surface chemistry of porous materials such as porous zeolite and metal—organic framework nanocrystals can be tailored to promote the formation of stable dispersions in, e.g., water, while maintaining dry networks of internal pores that are accessible to gas molecules. As a result of their permanent porosity, these liquids (e.g., aqueous fluids) can concentrate gases, including oxygen (O₂) and carbon dioxide (CO₂), to much higher densities than are found in typical aqueous environments. When the liquids are oxygenated, this allows record-high capacities of O₂, which can, e.g., be delivered to hypoxic red blood cells, highlighting the potential of this new class of porous liquids for physiological gas transport.

Water is the ubiquitous solvent for all biological processes and for many of the chemical transformations critical to sustainable energy generation, storage, and utilization. Its polarity and propensity for hydrogen bonding promote the solvation of polar substances but inhibit the dissolution of nonpolar ones, including most gases. The low solubility of gases in water—often an order of magnitude less than in common organic solvents—imposes fundamental limitations on many biomedical and energy-related technologies that require the transport of gas molecules through aqueous fluids. For instance, low densities of dissolved O₂ hinder tissue engineering and cell culture in vitro and make it challenging to treat various types of life-threatening hypoxia in vivo. Aqueous-phase gas transport also limits the performance of fuel cells and the space-time yield and efficiency of many important electrocatalytic reactions—including CO₂ reduction, N₂ reduction, and CH₄ oxidation.

### Compositions

The invention employs porous particles that are dispersible in a liquid. The liquid wets the exterior of the particles but not the interior of the pores. The liquid may be a polar liquid, e.g., a polar protic solvent, e.g., water, an alcohol, such as methanol, ethanol, isopropanol, or propan-1-ol, or a mixture thereof. In certain embodiments, porous liquids rely on the synthesis of porous particles, e.g., porous nanocrystals with hydrophobic internal surfaces and hydrophilic external surfaces. The hydrophobic internal surfaces prevent polar liquids, e.g., H₂O, from intruding into the porous networks of the nanocrystals by making it more thermodynamically favorable for H₂O to remain in the bulk liquid phase. The hydrophilic external surfaces, which may be intrinsic to the porous material or created through the covalent attachment or non-covalent association of hydrophilic or amphiphilic surface ligands, allow the particles, e.g., nanocrystals, to be uniformly dispersed in polar liquids, such as H₂O, to create a stable, homogeneous fluid. In addition to promoting dispersibility, surface ligands may also provide a kinetic barrier to liquid intrusion.

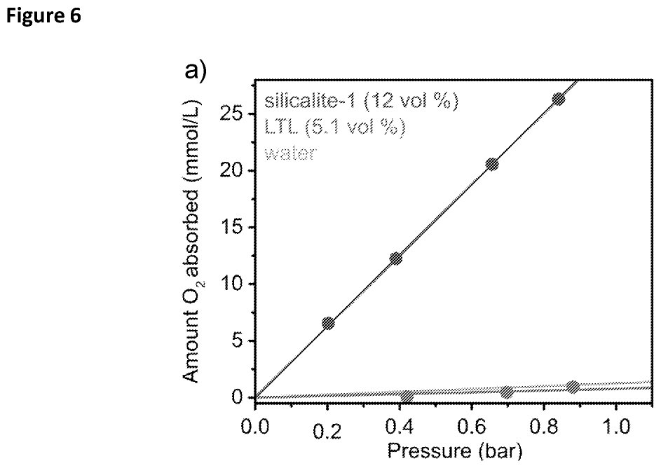

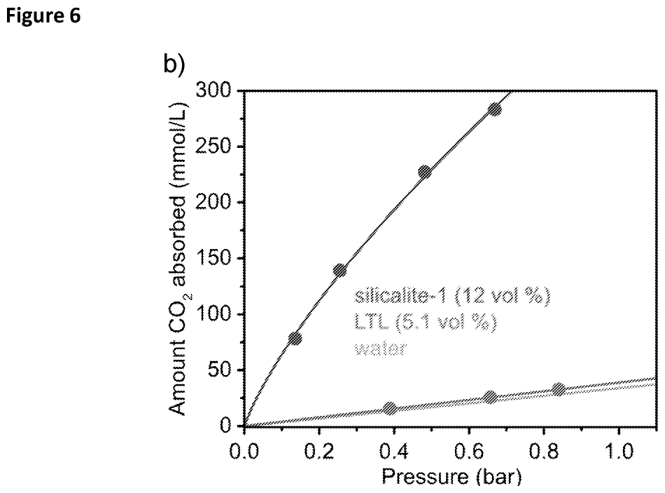

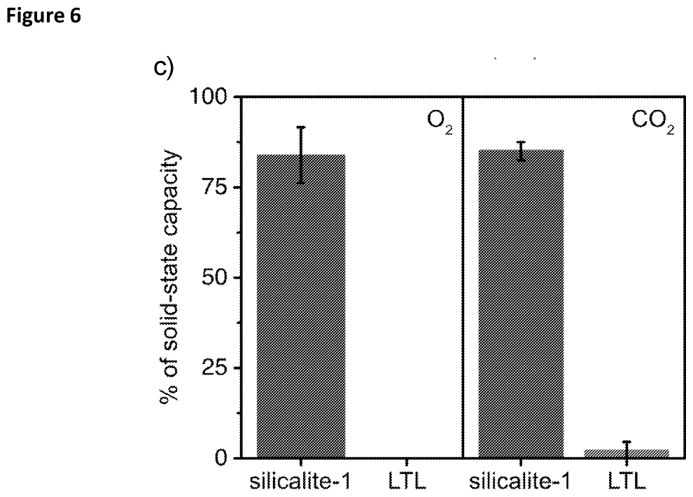

Owing to their high internal surface areas, variable pore diameters, and well-defined sites for external surface functionalization, two classes of highly tunable porous materials: zeolites and metal—organic frameworks may be employed in the invention. Particles may also include activated carbon or amorphous porous silica particles. Both zeolites and metal—organic frameworks feature internal networks of angstrom-sized pores that lead to high internal surface areas, often exceeding 1,000 m² per g or mL of material. Porous particles of the invention may have average pore diameters of between about 3 Å and about 20 Å, e.g., between about 3-5 Å, 4-6 Å, 4-10 Å, 5-10 Å, 5-15 Å, 6-8 Å, 7-9 Å, 9-11 Å, 10-12 Å, 10-15 Å, 10-20 Å, 12-15 Å, 13-18 Å, 14-18 Å, 17-19 Å, 18-20 Å, or about 19-20 Å, e.g., about 5 Å, about 10 Å, about 15 Å, or about 20 Å. Even when surface interactions with gas molecules are relatively weak, these high internal surface areas concentrate gas molecules to densities that surpass those which are possible in a conventional liquid and in the bulk gas phase—even after accounting for the space occupied by the atoms framing the pore (FIG. 4b). By preventing liquid, e.g., water molecules, from entering these pores, the invention provides porous liquids and brings the high gas capacities of porous materials to solutions, e.g., aqueous. Porous particles of the invention may range in cross-sectional dimension (e.g., diameter) from about 5 nm to about 1000 nm, e.g., between about 5-100 nm (e.g., about 5-10 nm, 5-15 nm, 5-25 nm, 10-20 nm, 25-50 nm, 20-40 nm, 30-60 nm, 50-75 nm, 60-80 nm, 75-100 nm, 70-90 nm, 80-95 nm, or 90-100 nm) or about 100-1000 nm (e.g., about 100-150 nm, 120-160 nm, 140-180 nm, 150-200 nm, 100-200 nm, 100-300 nm, 200-500 nm, 250-750 nm, 300-400 nm, 350-650 nm, 400-500 nm, 400-600 nm, 500-750 nm, 600-800 nm, 750-1000 nm, 600-950 nm, 700-900 nm, 800-1000 nm, or 900-1000 nm). The porous particles may account for less than 0.1 vol % or up to 90 vol % of the composition, for example between about 0.01 vol % to about 90 vol %, e.g., about 0.01 to about 1 vol % (e.g., about 0.01-0.05 vol %, 0.02-0.07 vol %, 0.04-0.09 vol %, 0.05-0.1 vol %, 0.06-0.12 vol %, 0.1-0.15 vol %, 0.1-0.2 vol %, 0.1-0.5 vol %, 0.2-0.6 vol %, 0.3-0.7 vol %, 0.4-0.9 vol %, 0.5-0.9 vol %, 0.5-1 vol %, or 0.9-1 vol %) or, e.g., about 1 vol % to about 10 vol % (e.g., about 1-2 vol %, 1-3 vol %, 1-4 vol %, 2-5 vol %, 2-6 vol %, 3-7 vol %,4-8 vol %, 5-7 vol %, 5-10 vol %, 6-9 vol %, 7-10 vol %, 8-10, or 9-10 vol %), or about 10 vol % to about 90 vol (e.g., about 10-15 vol %, 10-20 vol %, 10-50 vol %, 15-45 vol %, 25-50 vol %, 30-60 vol %, 40-80 vol %, 50-75 vol %, 50-90 vol %, 60-90 vol %, 65-85 vol %, 70-85 vol %, 75-90 vol %, or 80-90 vol %). Representative scanning electron microscopy (SEM) images of nanocrystals according to embodiments of the invention used to form liquid suspensions, e.g., colloidal solutions in water, of the invention are shown in FIGS. 16a-6h. Ambient temperature powder X-ray diffraction patterns of some compositions of the invention (e.g., liquid suspension of microporous particles of the invention) are shown in FIGS. 18a-18f and 19.

Certain embodiments of the invention include the use of various MFI-type zeolite nanoparticles, both in pure silica form (known commonly as “silicalite-1”) and in Al-containing form (known as “ZSM-5”). The Si:Al ratios may be up to 50 or from 50 to infinity.

The high internal surface areas and pore volumes of porous particles (e.g., microporous particles), such as those of the invention, can concentrate gas molecules through adsorption to far higher densities than can be dissolved within a typical liquid solvent—or than exist in a bulk gas phase—at a given temperature and pressure. Porous liquids can include porous crystals (e.g., nanocrystals) or organic cage molecules dispersed in bulky organic solvents or ionic liquids that are too large to diffuse through the pore entrances, leaving the pores vacant and accessible to gas molecules. Because of their intrinsic porosity, these liquids can store much higher quantities of gas molecules than the corresponding nonporous liquid. This sterics-based approach to creating permanent porosity within liquids is not, however, transferable to aqueous systems because a pore that is large enough to adsorb nearly any gas molecule will also be large enough to accommodate H₂O molecules. As a result, the high gas capacities of porous solids have yet to be exploited for aqueous-phase gas transport.

The invention includes liquids with permanent porosity and high gas sorption capacities based on thermodynamics rather than sterics (FIG. 4a). In some embodiments, porous particles (e.g., crystals e.g., nanocrystals) with hydrophobic internal surfaces and hydrophilic external surfaces are provided which form uniform, stable dispersions in a liquid (e.g., water) within which it is more thermodynamically favorable for liquid, e.g., water, to interact with other liquid (e.g., water) molecules in the bulk liquid phase than to fill the porous networks—leaving them dry and available to adsorb gas molecules (see, e.g., FIG. 4a). Exemplary gases include argon, oxygen, nitrogen, carbon dioxide, carbon monoxide, xenon, methane, helium, neon, and hydrogen.

The invention includes any particles, such as zeolites and metal—organic frameworks (MOFs), that can be synthesized with hydrophobic pore surfaces, e.g., in nanocrystalline form. The great range and variety of such materials makes these materials an advantageous—and highly tunable—platform to provide liquid (e.g., aqueous) solutions with permanent porosity. Moreover, solid powders of several hydrophobic zeolites and metal—organic frameworks, such as those described herein, can exclude liquid water from their internal pores at ambient pressure and temperature. For example, hydrostatic pressures in excess of 900 bar must be applied to force water into the pores of the pure-silica zeolite MFI (silicalite-1) at 25° C. This is because water intrusion into silicalite-1 (and other porous materials of the invention) is entropically disfavored since confined H₂O molecules have less mobility than bulk H₂O molecules and endothermic since surface—₂O interactions are too weak to compensate for the hydrogen bonding interactions between H₂O molecules that are lost during intrusion. Pressures of at least 200 bar are also required to force water into the pores of other pure-silica zeolites and hydrophobic zeolitic imidazolate frameworks (ZIFs). Porous particles of the invention may resist ingress of the liquid portion of the composition (e.g., water) up to applied pressures of about 1000 bar, e.g., up to about 1.5 bar, 2 bar, 5 bar, 10 bar, 20 bar, 50 bar, 75 bar, 100 bar, 150 bar, 200 bar, 300 bar, 400 bar, 500 bar, 600 bar, 700 bar, 800 bar, 900 bar, or 950 bar.

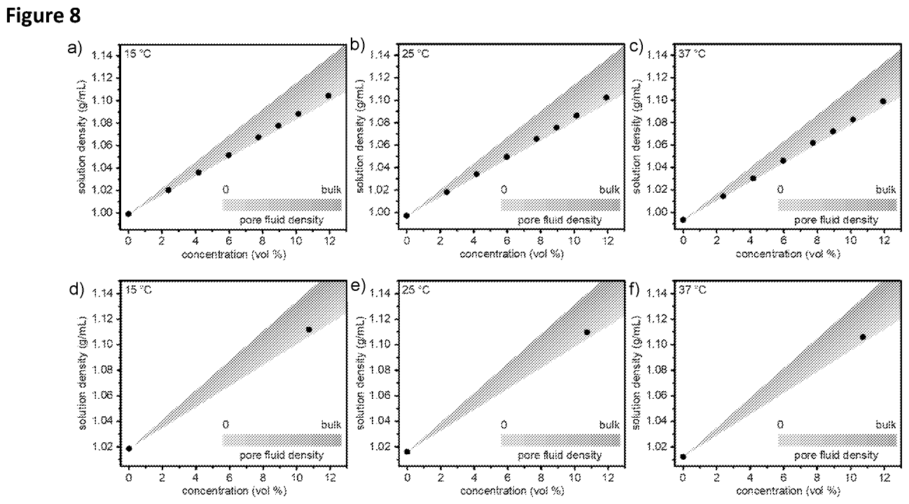

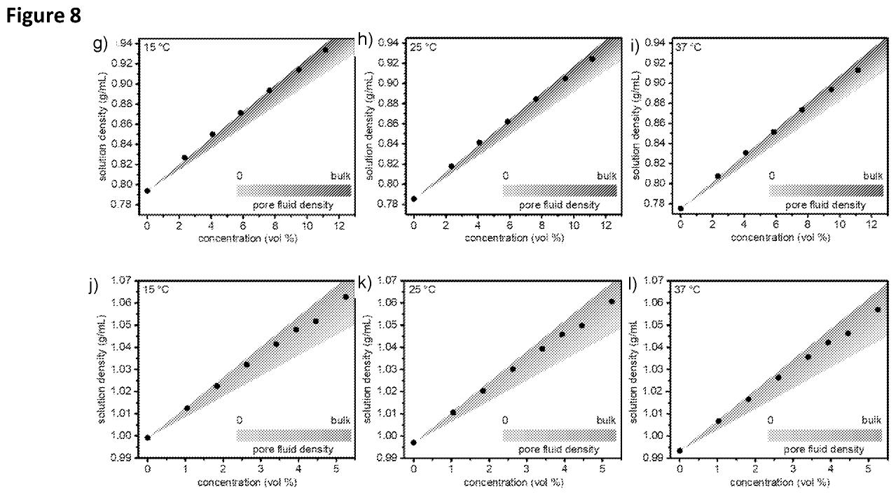

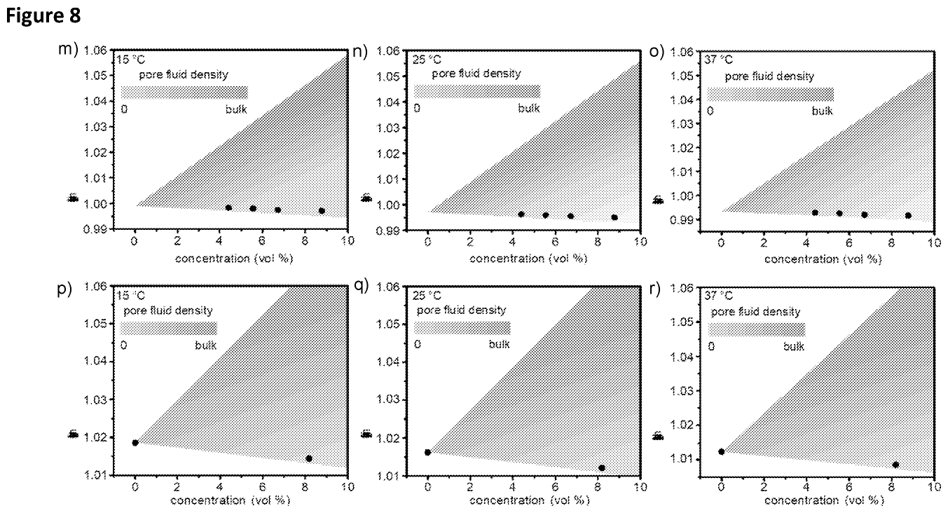

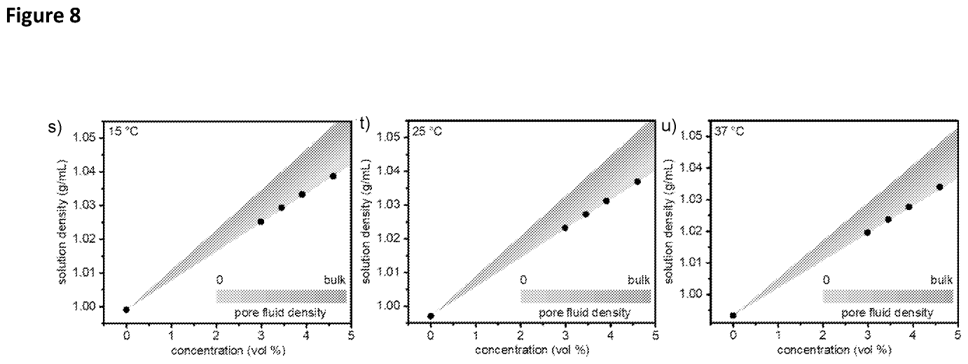

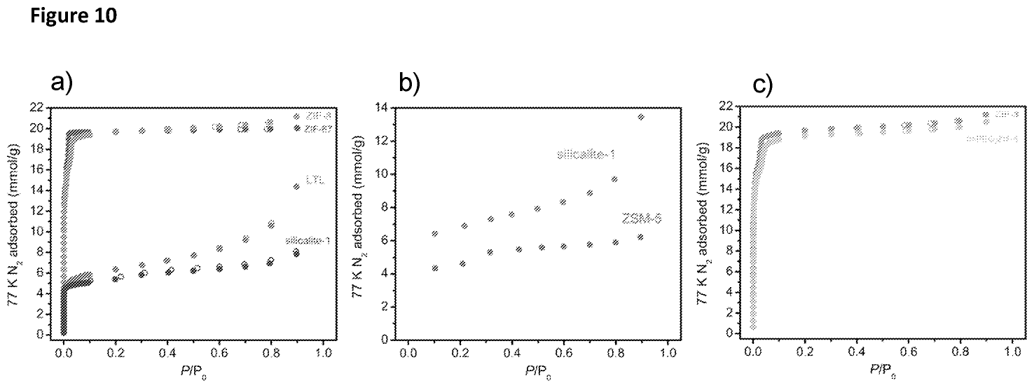

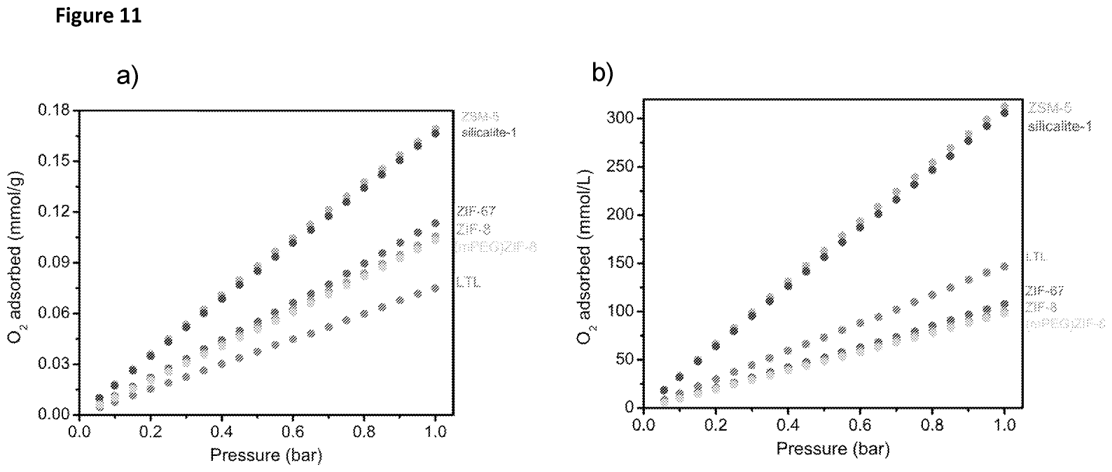

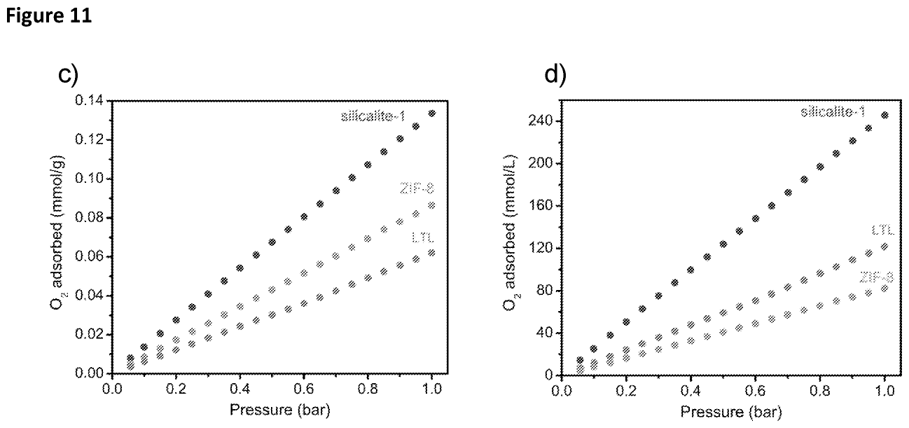

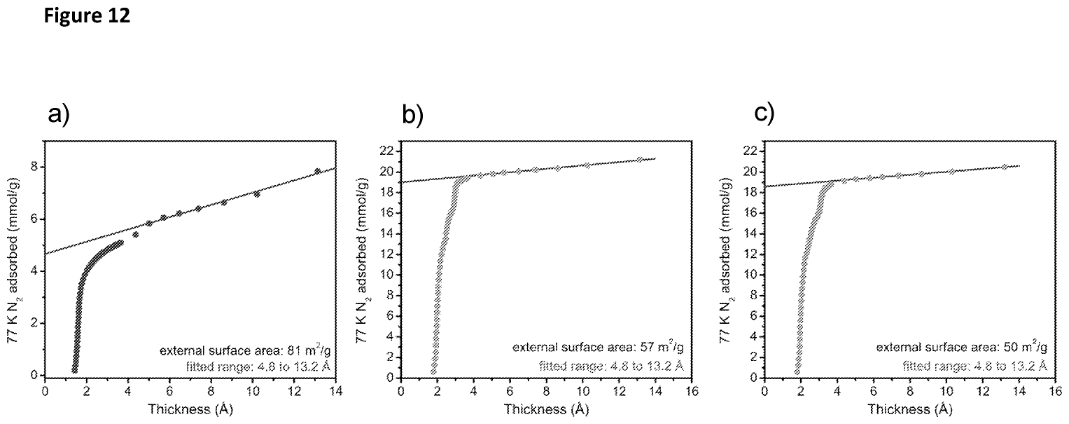

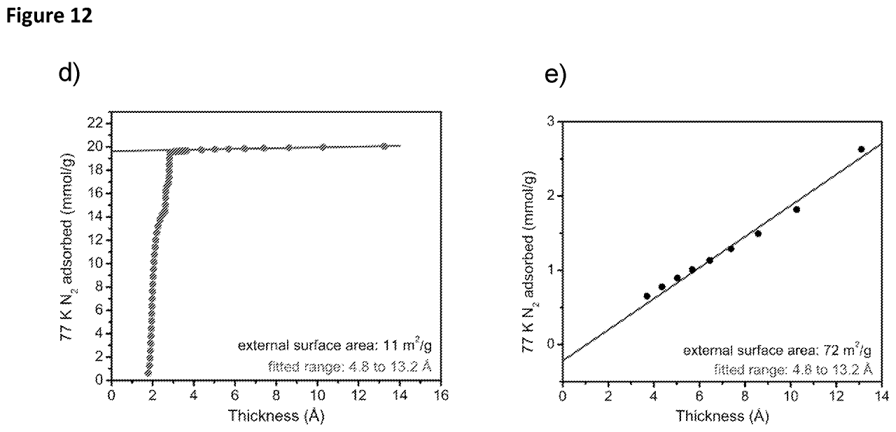

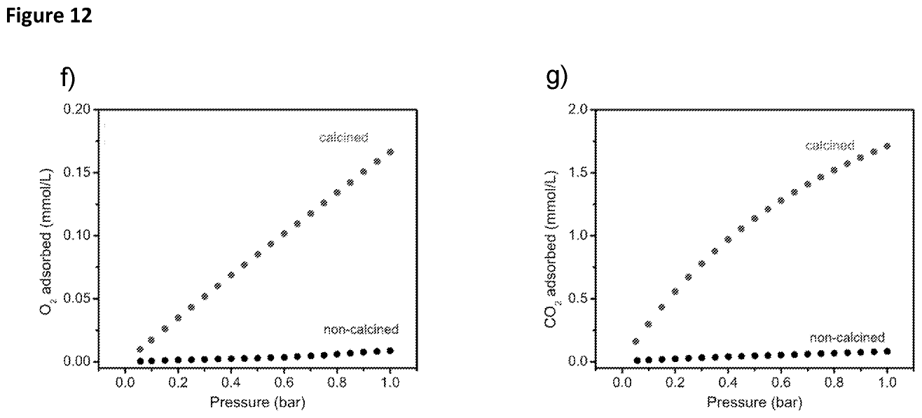

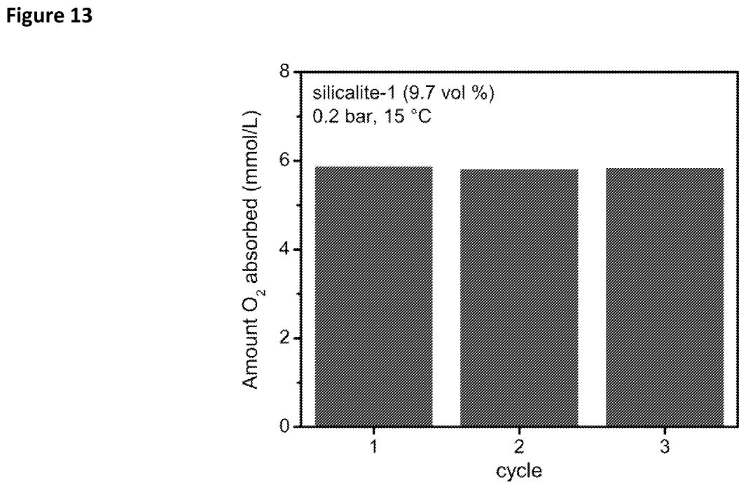

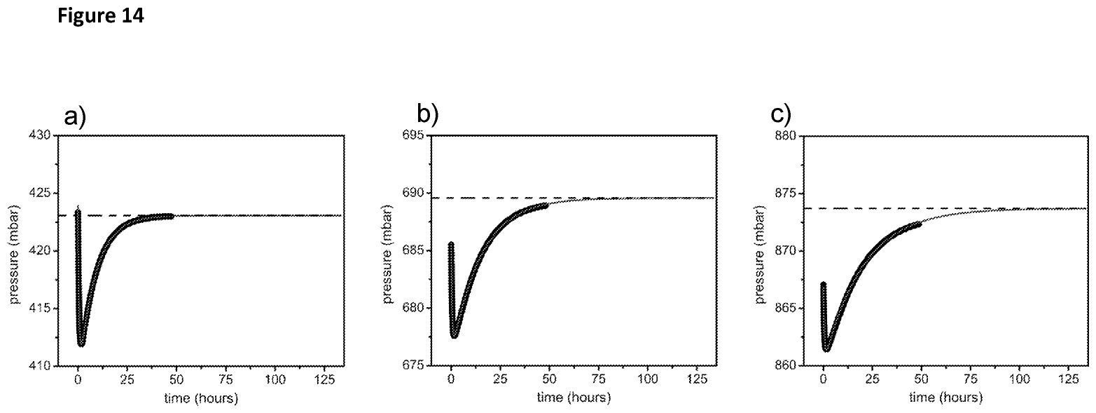

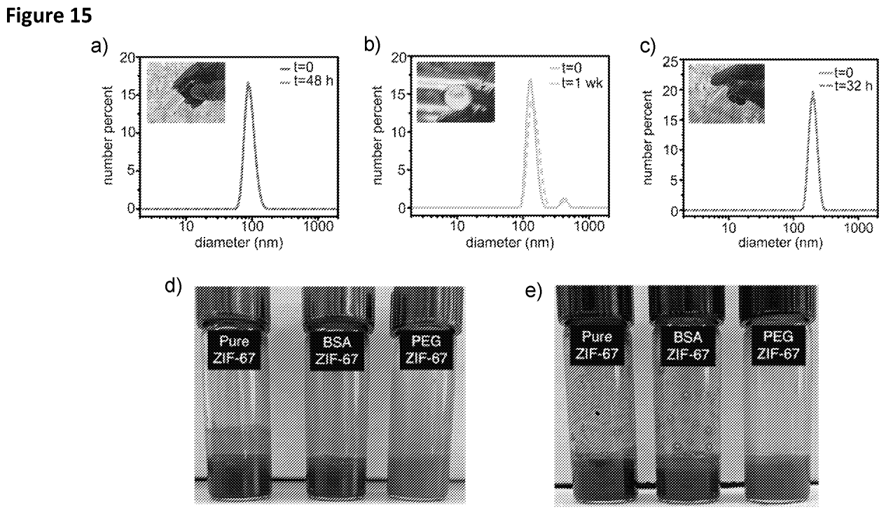

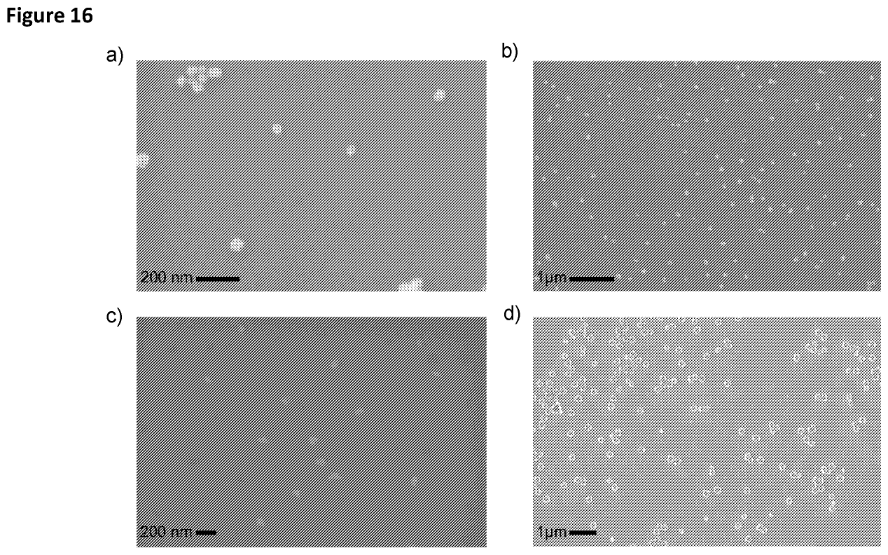

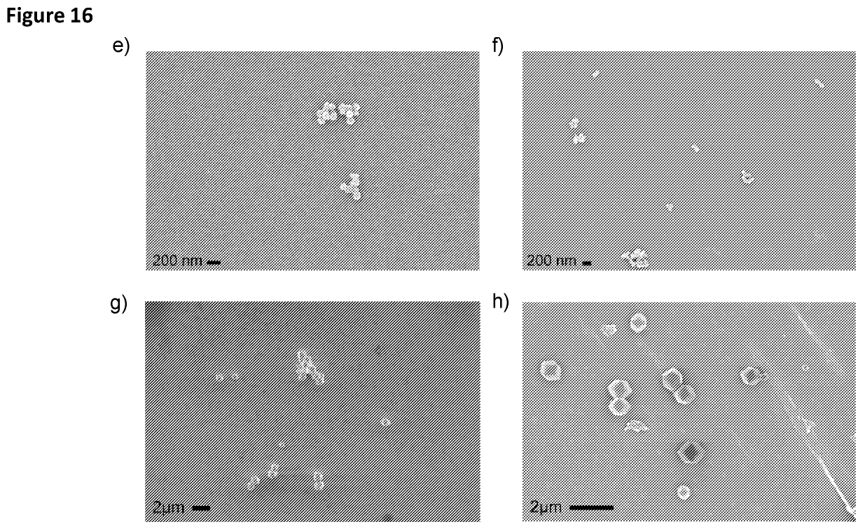

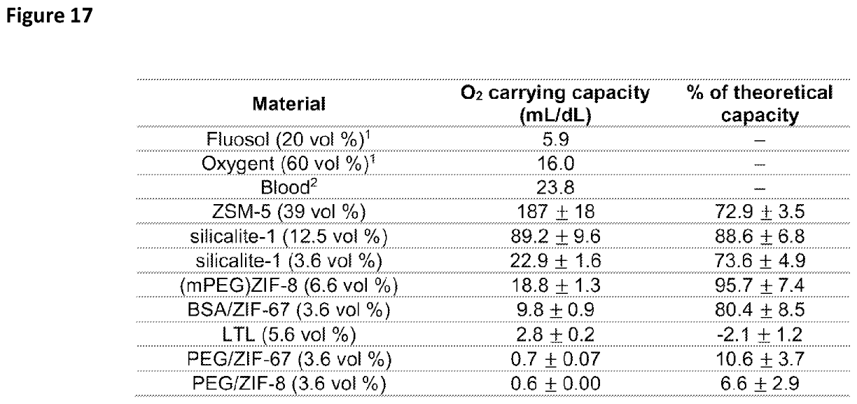

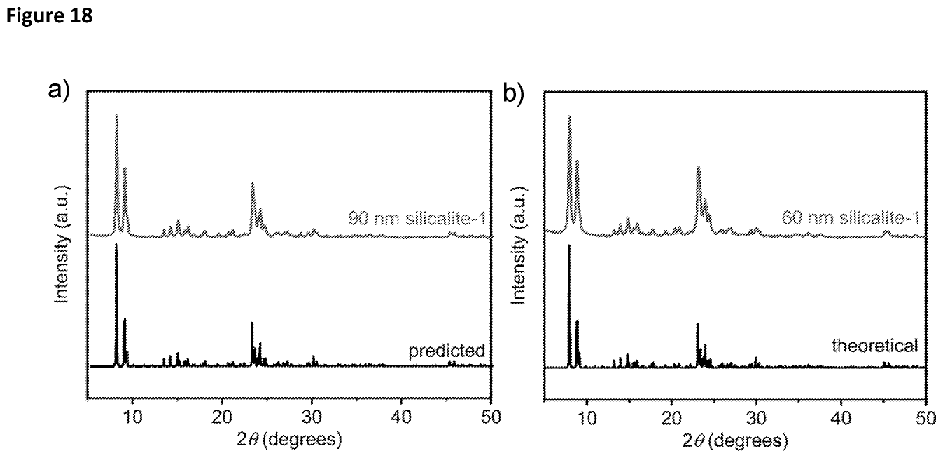

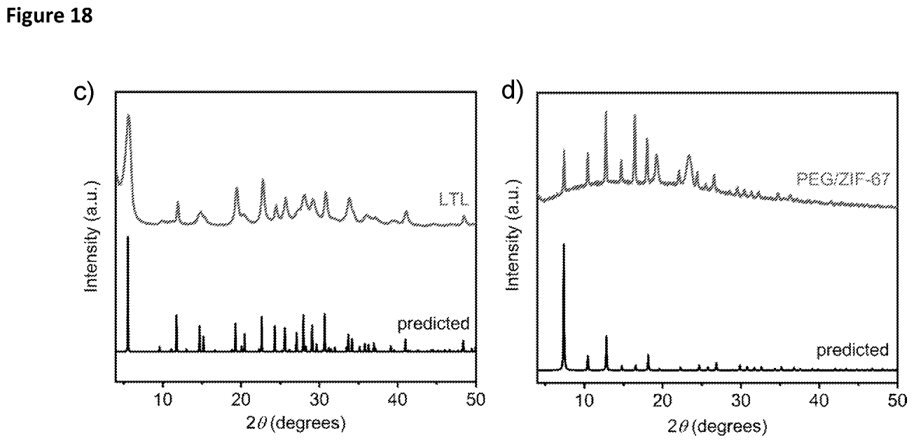

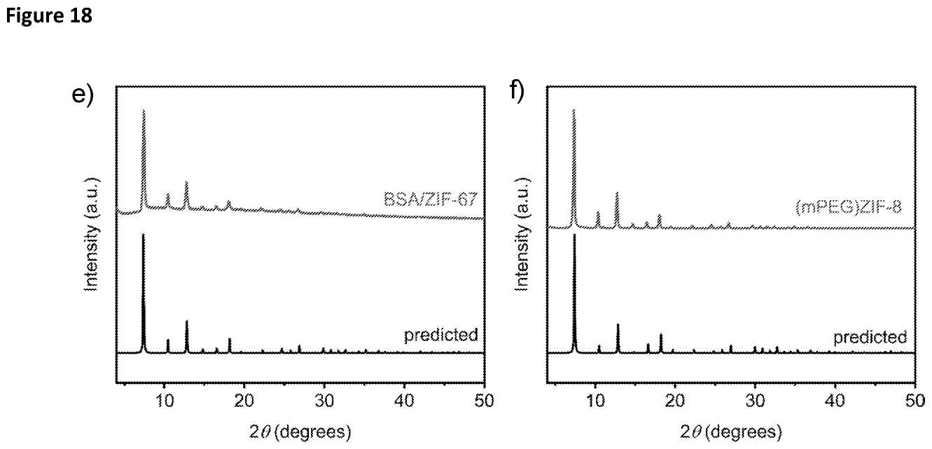

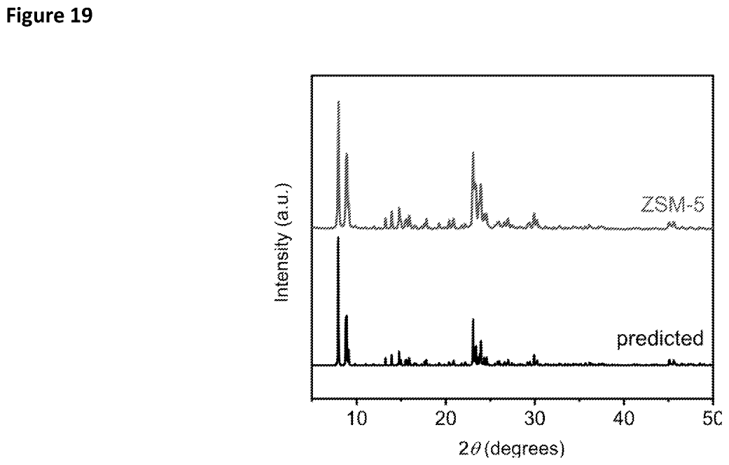

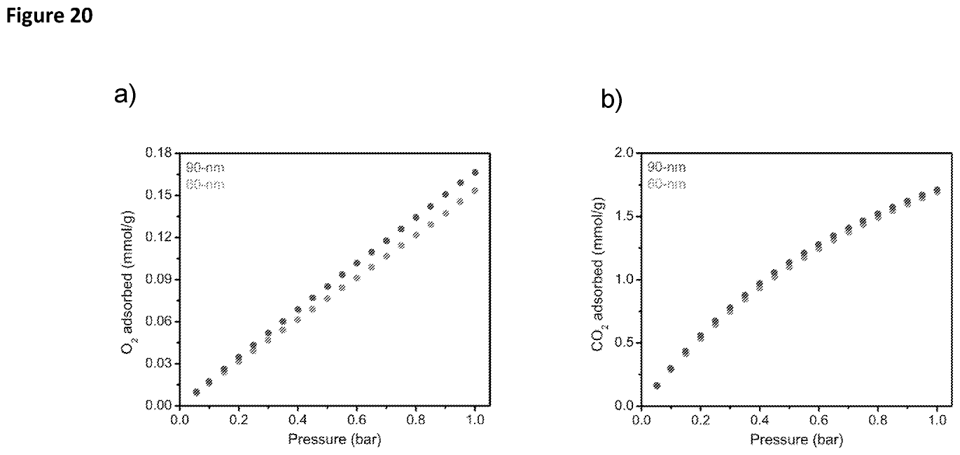

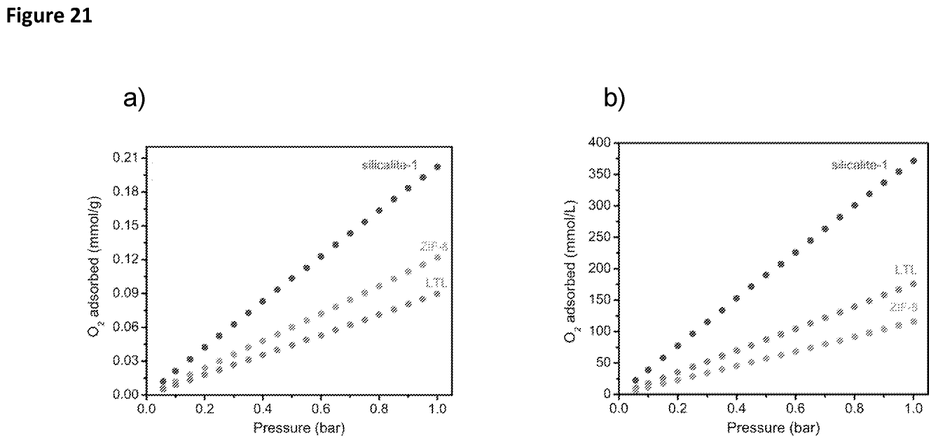

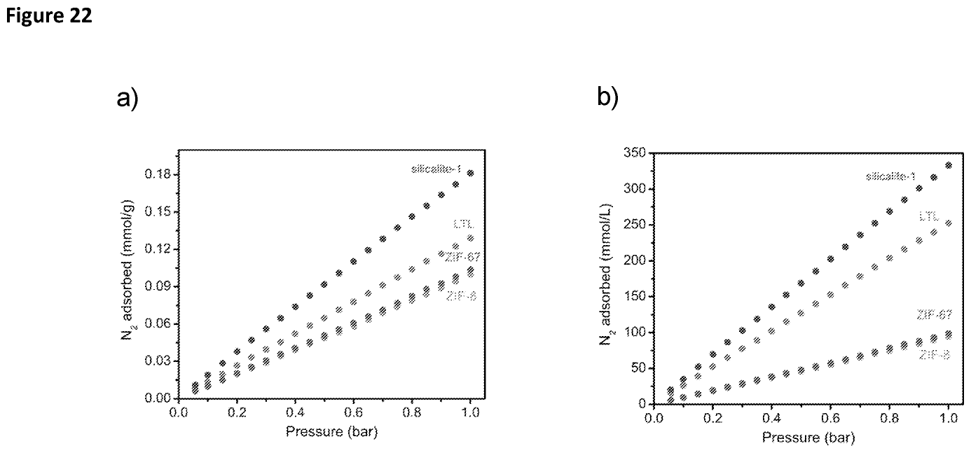

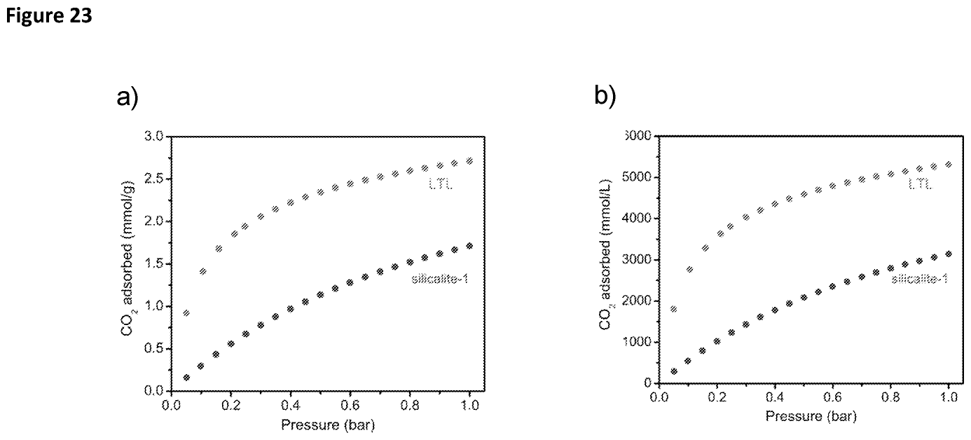

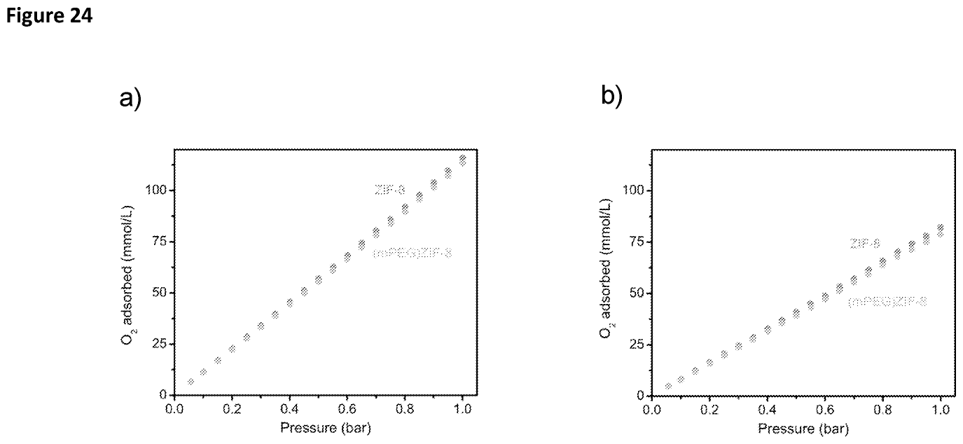

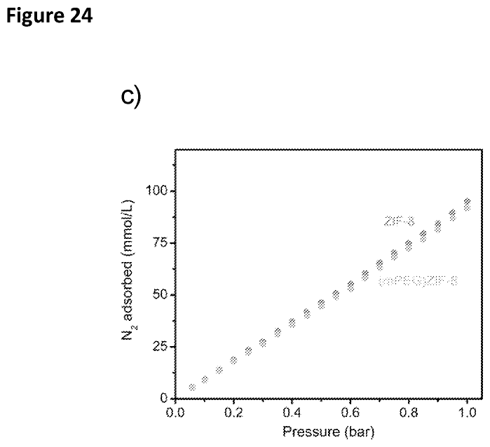

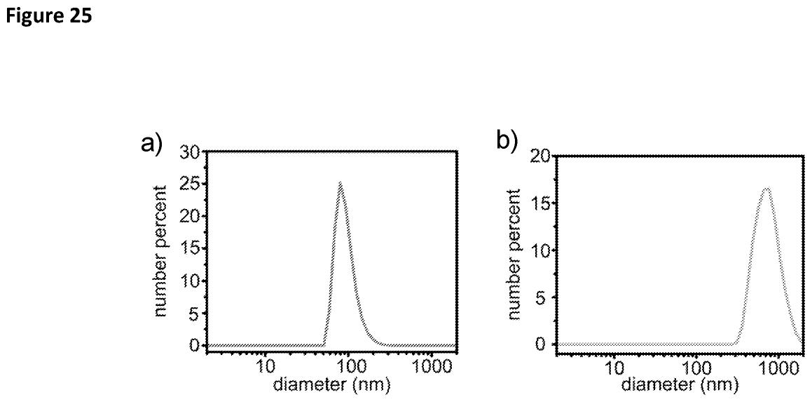

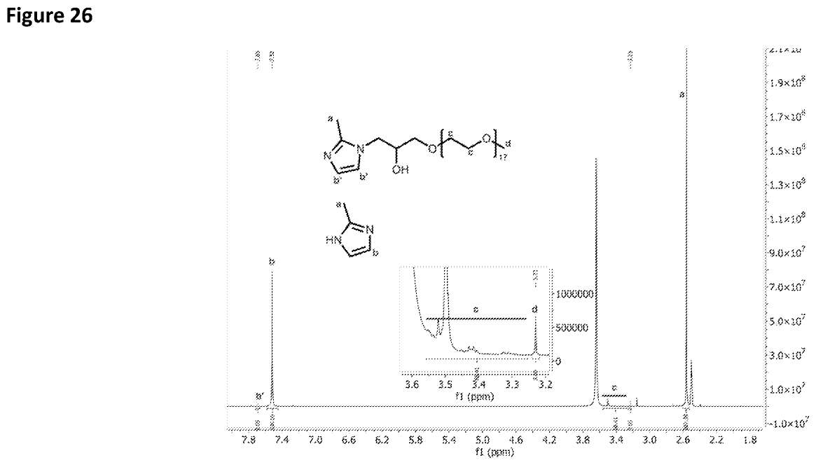

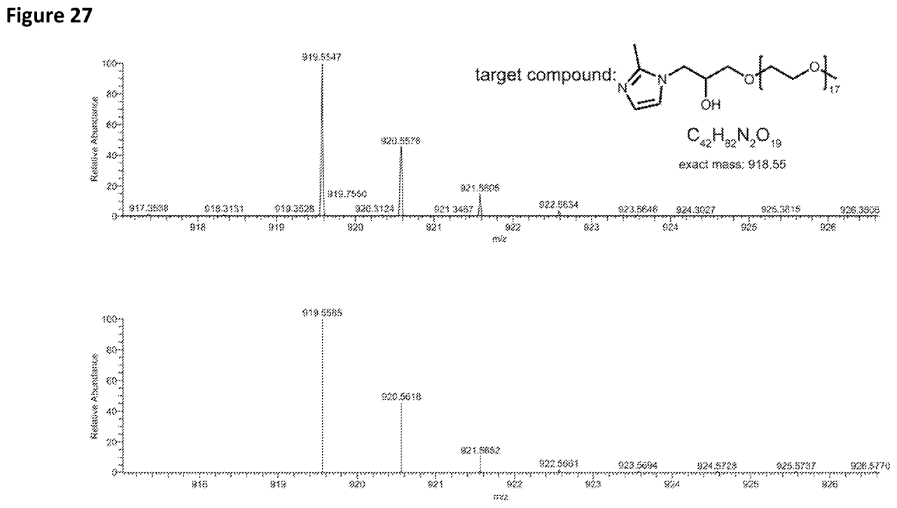

Although hydrophobic materials are not generally dispersible in polar solvents, particularly solvents such as water, pure-silica zeolites present a unique combination of hydrophobic internal pore surfaces templated by SiO₄ tetrahedra, which prevents water intrusion, and hydrophilic external surfaces including terminal silanol groups, which promote water dispersibility for sufficiently small particles (FIG. 4c). With an internal surface area of 457 m²/g (839 m²/mL) and established routes to produce uniform nanocrystals of variable sizes (see, e.g., FIG. 10a and Table 4), silicalite-1 can generate aqueous solutions with permanent porosity and high gas capacities. Even though it does not contain any inherently strong gas adsorption sites, silicalite-1 adsorbs over 230 times the amount of O₂ and 90 times the amount of CO₂ in the solid state as can be dissolved in water at 1 bar and 25° C. on a volumetric basis (FIG. 8b) (see Table 8 for gravimetric basis). In addition, NMR experiments suggest that at least some fraction of silicalite-1 pores are accessible to hyperpolarized Xe in water.

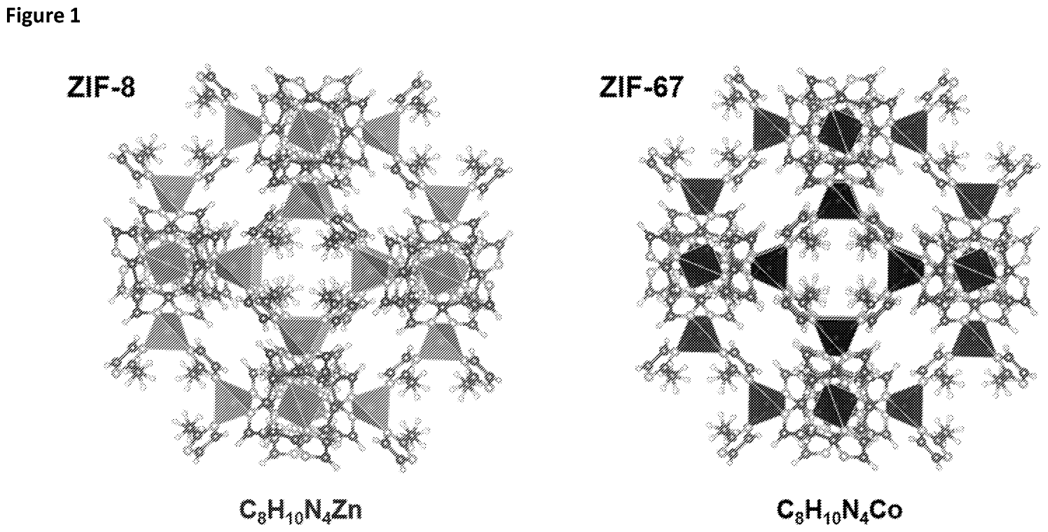

The thermodynamic approach described here to designing porous liquids is generalizable to a wide range of hydrophobic porous materials. For instance, there are currently over 50 known pure-silica zeolites and many other high-silica zeolites that should be hydrophobic enough to exclude water in colloidal solutions. Beyond zeolites, metal-organic frameworks (MOFs) offer access to even higher internal surface areas and gas capacities, along with substantially more structural and chemical diversity. Most hydrophobic MOFs, however, have relatively hydrophobic external surfaces and are not inherently dispersible in water. Many hydrophobic MOFs are also prone to hydrolysis, particularly at low concentrations. This is true for the isostructural hydrophobic frameworks Zn(mIm)₂ (ZIF-8; where mIm=2-methylimidazolate, see, e.g., FIG. 1) and Co(mIm)₂ (ZIF-67) (FIGS. 1 and 4d), nanocrystals of which rapidly aggregate in water and may degrade if a large excess of water is present. Surface functionalization strategies can be applied to disperse and stabilize hydrophobic particles, e.g., MOFs, in a liquid, e.g., water, providing a route to aqueous MOF solutions with permanent porosity as long as surface ligands promote dispersibility without infiltrating—or blocking access to—the framework pores (see, e.g., FIGS. 10a and 10c). Surface functionalization may be noncovalent or covalent.

Noncovalent surface functionalization with macromolecules such as polyethylene glycol (PEG) represents one approach for dispersing nanocrystals in solvents that would otherwise induce aggregation and precipitation.

As an alternative to (or in addition to) synthetic polymers porous particles of the invention may include surface coatings of globular water-soluble proteins (e.g., albumins, e.g., serum albumins, e.g., bovine serum albumin (BSA), ovalbumin, lactalbumin, human serum albumin (HSA), etc.). Such macromolecules are advantageous for non-covalent surface (e.g., ZIF surface) functionalization due to their large size, rigidity, and propensity to adsorb on hydrophobic surfaces. BSA is useful for adsorbing onto ZIF-8 and ZIF-67 external surfaces because of its large diameter (˜7 nm) and 17 permanent disulfide linkages that minimize its conformational flexibility—the combination of which should sterically preclude protein intrusion into the ZIF framework and preserve permanent porosity.

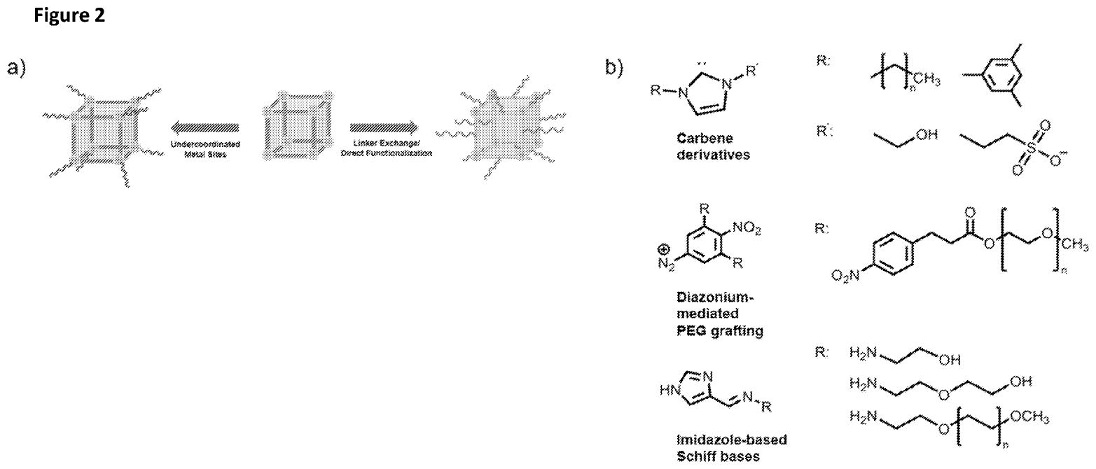

The invention also provides covalent surface functionalization approaches to producing dispersible porous particles which offer the potential for strongly bound and precisely located surface ligands that promote water dispersibility at lower loadings than more weakly associated surface ligands (FIGS. 2a-2b). For covalent functionalization to lead to a porous aqueous liquid, the surface ligand must by hydrophilic enough—and present at a high enough density—to promote water dispersibility, while short enough or bulky enough to prevent pore infiltration. In addition, functionalization must be confined to the external surface of the particle (e.g., nanocrystal) and not inhibit gas accessibility to the internal pore surfaces. As an alternative approach, the invention provides mIm surface ligands that open epoxide rings and form a β-hydroxyalkyl covalent linkage to the ZIF surface (FIG. 4d). Other surface chemistries are known in the art.

### Methods

The high gas capacities of the porous liquids reported here (see FIG. 17 and Tables 10-17) present intriguing possibilities for in vitro or in vivo gas, e.g., O₂, delivery. Nature evolved intricate and tightly regulated systems to transport O₂ in water over hundreds of millions of years, and it is challenging to deliver enough O₂ to prevent hypoxia when these systems are absent or fail. A variety of natural and synthetic gas carriers—including cell-free hemoglobin, heme mimics, perfluorocarbon emulsions, and lipid- or polymer-coated microbubbles—have been explored to deliver O₂ from aqueous fluids but overcoming issues that include limited gas-carrying capacity, poor control over release kinetics, lack of reversibility, large particle sizes, dose-limiting toxicity, and long-term stability remains an unsolved challenge. As a result, there are currently no FDA-approved injectable sources of O₂ or artificial blood substitutes despite decades of research.

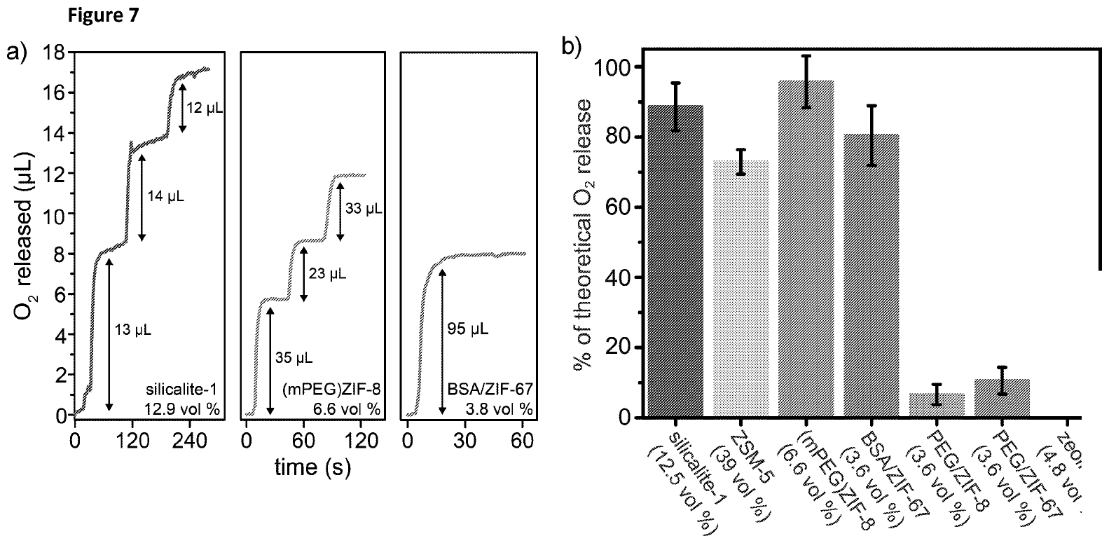

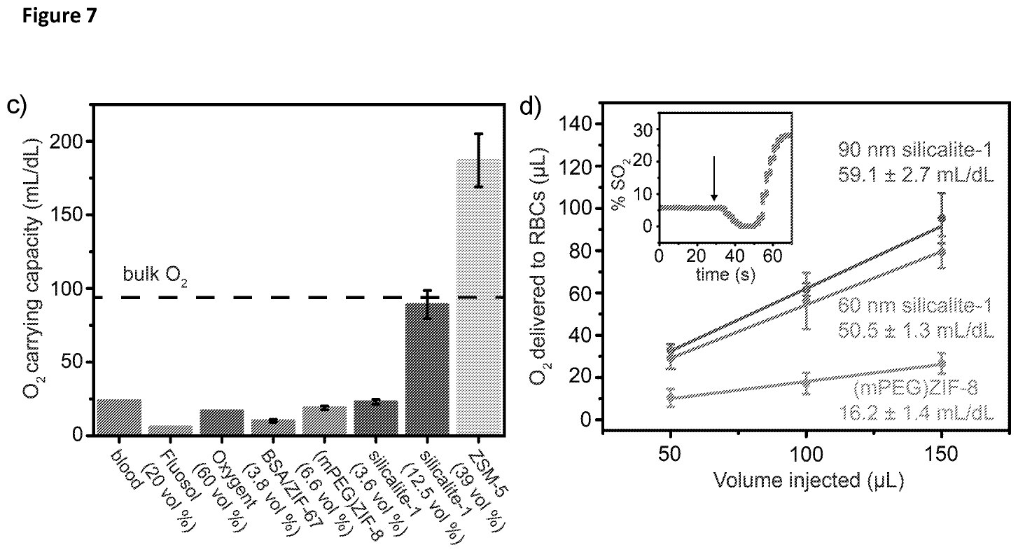

Compositions of the invention (e.g., silicalite-1 and ZSM-5) demonstrate surprisingly high oxygen carrying capacity compared to blood and other oxygen carrying liquids (e.g., Fluosol® and Oxygent™), as show in FIG. 7c. When oxygenated at 1 bar and 25° C., blood has an O₂ carrying capacity near 23 mL/dL (15 g Hb/dL), which is an order of magnitude larger than the 2.9 mL/dL that can be dissolved in pure H₂O. Among non-covalent O₂ carriers, lipid-coated microbubble dispersions (90 vol %) have been demonstrated with irreversible O₂ capacities that approach the gas-phase density of O₂ (91 mL/dL), while concentrated perfluorocarbon emulsions (60 vol %) have reached reversible O₂ capacities as high as 17 mL/dL (see FIG. 7c). Porous liquids offer a pathway to reversible O₂ capacities that far exceed these values, which would allow larger amounts of O₂ to be delivered from smaller volumes of an aqueous fluid. Since silicalite-1 and ZIF-8 nanocrystals adsorb 731 mL/dL and 241 mL/dL of O₂, respectively, in the solid state, low-concentration aqueous solutions should be able to deliver exceptionally high densities of O₂. Indeed, our 6.6 vol % solution of (mPEG)ZIF-8 nanocrystals has a measured O₂ carrying capacity that is similar to many perfluorocarbon emulsions, which have concentrations of at least 20 vol %. Moreover, at a concentration of just 2.5 vol %, our silicalite-1 solution has a measured O₂ capacity approaching that of blood. At a concentration of 12.5 vol %, this O₂ carrying capacity increases to 89±10 mL/dL, which is comparable to the density of bulk O₂ gas (FIG. 7c).

In addition to oxygen, other gases may be employed with the invention including argon, nitrogen, carbon dioxide, carbon monoxide, xenon, methane, helium, neon, or hydrogen. The compositions may be used to deliver or store any such gas for any appropriate purpose. For example, the compositions may be employed to increase volumetric mass transfer of a gas in a mass transfer limited process, e.g., catalysis, such as electrocatalysis.

Overall, these results show how to bring the high surface areas and gas capacities of porous solids to aqueous fluids. This approach has significant implications for biomedical and energy technologies, many of which are limited by the transport of gas molecules through aqueous environments. For instance, the porous water concept could lead to novel electrolytes that complement or replace gas diffusion electrodes in electrocatalysis or injectable sources of O₂ that could serve as artificial blood substitutes, bridge therapies for hypoxia induced by trauma, sensitizers to make cancerous tumors more responsive to radiotherapy, or media for organ and tissue preservation. Though many factors beyond gas carrying capacity need to be considered in order to translate these systems to viable technologies, there are myriad possibilities for designing hydrophobic zeolites and MOFs with different crystal structures, nanocrystal sizes and shapes, and external surface functional groups to create porous water with high gas capacities and properties tailored to a specific application.

### EXAMPLES

### Example 1. Methods and Theory

### Gas Adsorption Isotherms for Aqueous Colloidal Solutions

Free space measurements. Round-bottom glass sample tubes equipped with a Teflon-coated stir bar were attached to the instrument, and two temperature-controlled water baths were installed around the sample tube to control the sample and port temperatures. The sample tubes were evacuated, and the pressure transducers were then zeroed and scaled using the instrument software. Helium was dosed to the manifold to a pressure near 600 mbar, P_{dose}, and the valve to the sample was then opened. The final He pressure (P_{He,final}) was recorded after 1 min, and P_{dose}/P_{He,final} was used to calculate the volume of the empty tube (Vₛ) according to Eqn 1.

$${V}_{s} = {T}_{s} ( \frac{{P}_{d o s e} {V}_{m}}{{P}_{He , final} {T}_{m}} - \frac{{V}_{m}}{{T}_{m}} - \frac{{V}_{p}}{{T}_{p}} ) \qquad ( 1 )$$

After adding an aqueous solution to the tube and degassing (see below), a second iteration of the free space measurement was performed following the same dosing procedure, except for a longer wait time after opening the valve to the sample to allow the water vapor pressure to fully equilibrate. The final He partial pressure, P_{He,final}, was obtained by subtracting the sample vapor pressure previously measured during degassing from the total pressure. The free space was then calculated using Eqn 1.

Degassing. To degas aqueous solutions, the pressure in the sample tube was decreased slowly through a servo valve while stirring at 250 rpm until the pressure was close to the expected vapor pressure, at which point the sample was briefly pulsed to the turbomolecular pump several times. Degassing was considered complete when the pressure was near the expected sample vapor pressure and did not noticeably rise between pulses of the turbomolecular pump. The sample vapor pressure was then recorded for future use.

Gas dosing and equilibration. Prior to the measurement of each gas absorption isotherm (see Tables 2 and 3), the aqueous solution was degassed following the procedure described above. Then, O₂ or CO₂ was dosed to the gas manifold of the 3Flex. The manifold dose pressure (P_{dose}) required to reach a target final partial pressure (P_{gas}) was estimated from

$${P}_{g a s} = \frac{\frac{{P}_{d o s e} {V}_{m}}{R {T}_{m}}}{\frac{1}{R} ( \frac{{V}_{m}}{{T}_{m}} + \frac{{V}_{p}}{{T}_{p}} + \frac{{V}_{s}}{{T}_{s}} ) + {k}_{H , {H}_{2} O} {V}_{{H}_{2} O} + {k}_{H , np} {V}_{np}} \qquad ( 2 )$$

where R is the universal gas constant, Vₘ is the volume of the manifold, Vₚ is the volume of the sample port, k_{H,H}_{₂}_{O} is the Henry's constant for the gas solubility in water in units of mmol/L·mbar, V_{H}_{₂}_{O} is the volume of water in the sample, k_{H,np} is the Henry's constant for gas adsorption in the zeolite or ZIF nanocrystals as determined from solid-state isotherms, Vₙₚ is the volume of nanocrystals in solution, and Tₘ, Tₚ, Tₛ are the temperatures of the manifold, port, and sample, respectively.

When gas was dosed from the manifold to the sample by opening the sample valve, was is absorbed by the aqueous solution, and water was evaporated into the manifold simultaneously. Crucially, both processes must be allowed to reach equilibrium to record the true final partial pressure of the analysis gas and to accurately determine the amount of gas absorbed. As described below, absorption occurred much faster than water vapor equilibration for all solutions measured in this work. Typically, after equilibrium was reached, the sample valve was closed, and the manifold volume was evacuated. Then, the same gas was dosed to the manifold at a higher pressure and then the gas was dosed from the manifold to the sample.

Fitting equilibration data. When a fully or partially degassed solution is exposed to a higher gas pressure, the pressure above the sample will initially decrease as gas is adsorbed. Simultaneously, water will evaporate from the sample into the previously dry manifold volume. While the adsorption process was a relatively rapid process for all samples measured in this work, the water equilibration process was slow. By assuming that the source of water vapor is infinite and that the greatest rate-limiting factor is the constricted volume of the manifold, the equilibration process can be modeled by integrating the Sampson flow with respect to time as

Pₘ(t)=a+be^{ct} (3)

where a, b, and c are constants that depend on initial sample pressure, viscosity, and the volume of constriction. From Eqn 3, we can approximate that water equilibration follows a pseudo-first order rate law that depends on the initial sample vapor pressure. As gas sorption can also be well-described with a pseudo-first order rate law, the entire process can be approximated as

$$P ( t ) = {A}_{a d} {e}^{- t / {t}_{ad}} + {A}_{C {O}_{2}} {e}^{- t / {t}_{{CO}_{2}}} + {A}_{e q} {e}^{- t / {t}_{eq}} + {P}_{f} \qquad ( 4 )$$

where A_{ad} is a pressure-dependent factor for the adsorption-dominated region, t_{ad} is the rate constant associated with the adsorption-dominated process, A_{CO}_{₂} is a pressure-dependent factor for the absorption of CO₂ in water, t_{Co}_{₂} is the rate constant associated with CO₂ absorption in water, A_{eq} is a pressure-dependent factor for the water equilibration region, t_{eq} is the rate constant associated with the water evaporation process, and P_{f} is the expected final equilibration pressure for the system. Note that A_{CO}_{₂} and t_{CO}_{₂} were omitted for O₂ measurements. The resulting fits to raw pressure vs time data were used to determine the final equilibration pressure for each isotherm point (see, Tables 10-12, and FIGS. 14a-14c).

Calculation of amount absorbed. After equilibrium is reached, the excess amount of gas absorbed by the solution can be calculated using

$${n}_{a d s} = \frac{{P}_{d o s e} {V}_{m}}{R {T}_{m}} - {P}_{g a s} ( \frac{1}{R} ) ( \frac{{V}_{m}}{{T}_{m}} + \frac{{V}_{p}}{{T}_{p}} + \frac{{V}_{s}}{{T}_{s}} ) \qquad ( 5 )$$

where P_{dose} is the pressure dosed to the manifold and P gas is the final partial pressure of O₂ or CO₂.

When a gas has been dosed to the solution multiple times without degassing, the previous amount of gas adsorbed (n_{ads,i}) and in the bulk gas phase inside the sample tube must be accounted for using

$${n}_{ads , tota1} = \frac{{P}_{d o s e} {V}_{m}}{R {T}_{m}} + {P}_{gas , 1} ( \frac{1}{R} ) ( \frac{{V}_{p}}{{T}_{p}} + \frac{{V}_{s}}{{T}_{s}} ) + {n}_{ads , 1} - {P}_{gas , 2} ( \frac{1}{R} ) ( \frac{{V}_{m}}{{T}_{m}} + \frac{{V}_{p}}{{T}_{p}} + \frac{{V}_{s}}{{T}_{s}} ) \qquad ( 6 )$$

where P_{gas,2} is the new equilibrium partial pressure of sorbent gas and n_{ads,total} is the total moles of gas absorbed. The values for P_{gas,1} and P_{gas,2} are both obtained from fitting pressure vs time data as described above.

### Oxygen Release Measurements in Deoxygenated Water

Due to the design of the electrode, two temperature compensations were required for each mg/L reading. The first of these was a solubility correction, accounting for differences in the equilibrium mg/L corresponding to the same pO₂ at different temperatures. This was required to account for small difference between the measurement and calibration temperature over time (generally 1-4° C.). The following equation was used to perform this correction:

$${( {c O}_{2} )}_{comp} = {( {c O}_{2} )}_{m e a s} * \frac{{H}_{{T}_{m e a s}}}{{H}_{{T}_{cal}}} \qquad ( 7 )$$

where cO₂ is given in units of mg/L, (cO₂)comp and (cO₂)ₘₑₐₛ correspond to the compensated and measured cO₂, respectively, and H_{Tmeas} and H_{Tcal} correspond to the Henry's constants of water at the temperature of the measurement and the temperature of the calibration, respectively.

A second temperature compensation was also required due to the effects of temperature on the signal of the amperometric sensor. This correction, given by the manufacturer and applicable in the range where the measured temperature is within ±3° C. of the calibration temperature, is given by

(cO₂)_{comp}=(cO₂)ₘₑₐₛ*A^{T}^{_{cal}}^{-T}^{ₘₑₐₛ}⁾ (8)

where A is a temperature compensation constant (calibrated by the manufacturer and equal to 1.0176 for the sensor used in all measurements reported here). Note that these temperature corrections were only performed for the final mg/L readings, as initial O₂ concentrations in deoxygenated solution were within error of the baseline.

Control experiments were conducted by injecting nitrogenated aqueous solutions of porous nanocrystals into deoxygenated water (Table 18). In all control experiments, there were negligible changes to the measured O₂ concentration in deoxygenated water, confirming that no external sources of O₂ were introduced during the injection.

The amount of oxygen released from aqueous solutions of zeolite and MOF nanocrystals to deoxygenated water was calculated by:

n_{delivered}=n_{water,f}−(n_{water,i}−n_{water,ejected}) (9)

where n_{water,f} is the moles of O₂ in bulk water after injection, n_{water,i} is the moles of O₂ initially in the deoxygenated bulk water. Since the vial has a fixed volume and begins filled with deoxygenated water, the injection of a known volume of dispersion leads to the ejection of a corresponding volume of deoxygenated water, whose total moles of O₂ is denoted by n_{water,ejected}. Using the compensated cO₂ values, this calculation becomes:

O_{2,delivered}=V_{H}_{₂}_{O,f}(cO₂)_{f,comp}−cO₂_{ᵢ}(V_{H}_{₂}_{O,i}−Vᵢₙⱼ) (10)

Where O_{2,delivered} is the amount of O₂ in μg, (cO₂)_{f,comp} , comp is the compensated final cO₂ after injection, expressed in mg/L, V_{H}_{₂}_{O,f} is the final volume of bulk H₂O after injection in mL, Vᵢₙⱼ is the volume of injection in mL, V_{H}_{₂}_{O,i} is the initial volume of bulk H₂O before injection in mL, and cO₂_{ᵢ} is the initial concentration of O₂ in the vial.

To calculate the total O₂ carrying capacity of the dispersion, one must also consider the amount of O₂ remaining inside the pores of the nanocrystals at the final pO₂ to which the system is equilibrated. For this, one must first find O_{2, delivered,NC}, the amount of O₂ delivered by the nanocrystals alone. Since the total delivered O₂ (in μg) is the sum of the O₂ delivered by the nanocrystals and that delivered by the water in the dispersion, rearranging this sum yields:

O_{2,delivered,NC}=O_{2,delivered}−χ_{H}_{₂}_{O}VᵢₙⱼH_{H}_{₂}_{O,oxρH}_{₂}_{O,ox}pO_{2,ox}×31999 (11)

where the last term corresponds to the O₂ delivered by the water in the dispersion, and where χ_{H}_{₂}_{O} is the volumetric fraction of water in the injected dispersion, ρ_{H}_{₂}_{O,ox} is the density of water at the oxygenation temperature of the dispersion prior to addition in g/mL, H_{H}_{₂}_{O,ox} is the Henry's constant of the water at the oxygenation temperature in mmol/g/bar, and pO_{2,ox} is the partial pressure of O₂ at which the dispersion was oxygenated in bar (0.2 bar for air-equilibrated samples and 1 bar for samples equilibrated with pure O₂).

With this value, one can now find the amount of O₂ remaining in the nanocrystals. By assuming that all experiments are performed in the Henry regime (namely, that the amount of O₂ adsorbed has a linear dependence on pressure, which is confirmed by the solid-state adsorption data), the total O₂ in the nanocrystals of the dispersion is equivalent to:

$${O}_{2 , total , NC} = \frac{{O}_{2 , delivered , NC}}{( {p O}_{2 , o x} - {p O}_{2 , f} )} {p O}_{2 , ox} \qquad ( 12 )$$

where pO_{2,f} is the final pO₂ of the system in bar.

Combining with the O₂ delivered by the water in the injected dispersion, one can calculate the total O₂ carrying capacity of the aqueous solution, C_{O2}, in mL per dL as:

$${C}_{{O}_{2}} = {p O}_{2 , ox} ( \frac{{O}_{2 , delivered , NC}}{( {p O}_{2 , eq} - {p O}_{2 , f} )} + {χ}_{{H}_{2} O} {V}_{inj} {H}_{{H}_{2} O , eq} {ρ}_{{H}_{2} O , eq} ) \times \frac{22.414}{31.999} \times 100 \qquad ( 13 )$$

To calculate the % of theoretical capacity for each aqueous solution, the following equation was used:

$$\frac{{O}_{2 , delivered , NC}}{{O}_{2 , theoretical , NC}} \times 100 \% \qquad ( 14 )$$

where O_{2,theoretical,NC} is the theoretical amount of O₂ released by the nanocrystals in the aqueous solution, with both parameters above given in terms of μg O₂.

Here, O_{2, theoretical,NC} can be calculated from solid-state O₂ adsorption isotherms (see FIGS. 11a-11d, 21a-21b, and 24a-24c, and Table 5). Since the total O₂ in the nanocrystals, as equilibrated at a pressure pO_{2,eq} prior to injection, can be partitioned into the O₂ that is released plus the O₂ that remains adsorbed inside the nanocrystals, this can be rearranged to give:

O_{2,theoretical,NC}=O_{2,NC,ox}−O_{2,NC,adsorbed} (15)

Where O_{2,NC,ox} is the amount of O₂ in the starting solution, and O_{2, NC,adsorbed} is the amount that remains inside the nanocrystals. Substituting known parameters for both of these variables yields:

O_{2,theoretical,NC}=C_{NC}Vᵢₙⱼ(H_{NC,eq}pO_{2,ox}−H_{NC,f}pO_{c,f,calc})×31999 (16)

Where C_{NC} is the concentration of nanocrystals in the dispersion in g/mLH_{NC,eq} and H_{NC,f} are the Henry's constants of the nanocrystal at the temperature the dispersion was oxygenated at and at the final temperature post-injection, respectively, and pO_{2,f,calc} is the calculated partial pressure of O₂ at the final temperature post-injection, respectively.

To calculate pO_{2,f,calc}, the total number of moles of O₂ in the final solution, n_{f}, is given by:

n_{f}=n_{NC,f}+n_{H}_{₂}_{O,f}+n_{excess,adsorbed,f} (17)

where n_{NC,f} is the final moles of O₂ in the nanocrystals, n_{H}_{₂}_{O,f} is the final moles of O₂ in the water, and n_{excess,adsorbed,f} is any moles of O₂ that are adsorbed by existing nanocrystals already present in the vial—this latter term is only needed in cases where multiple injections were performed sequentially into the same vial.

The final number of moles of O₂ is equal to the initial moles of O₂ present in water (nᵢₙᵢₜᵢₐₗ), plus the O₂ injected (n_{injected}) and the O₂ already adsorbed in “previous” nanocrystals from previous injections still in the vial (n_{initial,NC,previous}), minus the O₂ ejected (n_{ejected}):

n_{f}=n_{NC,f}+n_{H}_{₂}_{O,f}+n_{excess,adsorbed,f}=n_{injected}+nᵢₙᵢₜᵢₐₗ−n_{ejected}+n_{initial,NC,previous} (18)

Note that for measurements performed using fresh deoxygenated water and no prior injections, the terms n_{excess,adsorbed,f} and n_{initial,NC,previous} are both zero.

Expanding each term:

n_{NC,f}+n_{H}_{₂}_{O,f}+n_{excess,adsorbed,f}=pO_{2,f}(C_{NC}VᵢₙⱼH_{NC,f})+pO_{2,f}(V_{H}_{₂}_{O,f}H_{H}_{₂}_{O,f}ρ_{H}_{₂}_{O,f})+pO_{2,f}(H_{NC,f}N_{NC,previous}) (19)

And

n_{injected}+nᵢₙᵢₜᵢₐₗ−n_{ejected}+n_{initial,NC,previous}=VᵢₙⱼpO_{2,eq}(C_{NC}H_{NC,eq}+χ_{H}_{₂}_{O}H_{H}_{₂}_{O,eqρH}_{₂}_{O,eq})+pO_{2,i}H_{H}_{₂}_{O,iρH}_{₂}_{O,i}(V_{H}_{₂}_{O,i}−Vₑⱼ)+H_{NC,eq}pO_{2,eq}N_{NC,previous} (20)

Where V_{H}_{₂}_{O,f} is the final volume of water in the measurement vial, ρ_{H}_{₂}_{O,i} and p H2of are the densities of water at the initial and final temperature, respectively, H_{H}_{₂}_{O,i} and H_{H}_{₂}_{O,f} are the Henry's constants of water (Table 7) at the initial and final temperature, respectively, N_{NC,previous} is the amount of nanocrystals still in the vial from prior injections (expressed in g).

Setting these two expressions equal, collecting terms, and solving for pO_{2,f} yields:

$${p O}_{2 , f} = \frac{{V}_{inj} {p O}_{2 , eq} ( {χ}_{NC} {H}_{NC , eq} + {χ}_{{H}_{2} O} {H}_{{H}_{2} O , eq} {ρ}_{{H}_{2} O , eq} ) + {H}_{NC , eq} {p O}_{2 , eq} {N}_{NC , previous}}{( {χ}_{N C} {V}_{inj} {H}_{NC , f} + {V}_{{H}_{2} O , f} {H}_{{H}_{2} O , {T}_{f}} {ρ}_{{H}_{2} O , {T}_{f}} + {H}_{NC , f} {N}_{NC , previous} )} + \frac{{p O}_{2 , i} {H}_{{H}_{2} O , i} {ρ}_{{H}_{2} O , i} ( {V}_{{H}_{2} O , i} - {V}_{ej} )}{( {χ}_{N C} {V}_{inj} {H}_{NC , f} + {V}_{{H}_{2} O , f} {H}_{{H}_{2} O , {T}_{f}} {ρ}_{{H}_{2} O , {T}_{f}} + {H}_{NC , f} {N}_{NC , previous} )} \qquad ( 21 )$$

This pO_{2,f} can then be used in Eqn 16 for calculating the theoretical O₂ delivery for the nanocrystals in the dispersion.

### Oxygen Release Measurements in Packed Red Blood Cells (See Tables 19-27)

Blood gas and co-oximetry (CO-ox) data were obtained using a Radiometer ABL 90 Co-Ox Flex. Citrate-buffered packed red blood cells from donated human blood (hemoglobin, ˜7 g/dL; pH 7.1; T=25° C.) was first desaturated under flowing 95:5 N₂/CO₂ to an oxyhemoglobin saturation of 0-10%. Baseline hemoglobin, blood gas, and CO-ox values were measured prior to sample addition. Gas chromatography vials (2 mL) each fitted with a septa cap and stir bar were filled with 2 mL of deoxygenated blood. For a given measurement, a colloidal solution (stored under O₂ or N₂) was drawn into a glass syringe. During addition to the blood, a vent syringe was added to the vial to allow the excess blood displaced by the sample volume to exit. Both needles were removed, and the vial was stirred for 5 min prior to a CO-ox measurement. As a secondary control, the above experimental procedure was repeated using 5% dextrose (absent any nanocrystals).

The amount of O₂ delivered to the packed red blood cells was calculated by:

$$Vol of {O}_{2} ( mL ) = [ ( \frac{1.39 mL {O}_{2}}{g {O}_{2} Hb} \times ct Hb \times {F O}_{2} Hb ) + ( 0.0 \; 039 {P O}_{2} ) ] \times dL blood \qquad ( 22 )$$

where 1.39 mL O₂/g O₂Hb is the gravimetric O₂ capacity of fully saturated oxyhemoglobin (O₂Hb), ctHb is the total hemoglobin count in g/dL blood, FO₂Hb is the fraction of oxyhemoglobin to total hemoglobin expressed as a percentage, and 0.0039 mL O₂/mmHg/dL blood is the Henry's constant for O₂ solubility in blood at 25° C. The first term of the equation represents the O₂ bound to hemoglobin, while the second term represents the dissolved O₂ in the blood.

The equilibrated pO₂ after most sample injections was below the lower detection limit of the instrument used in this study (31.1 mmHg). Since pO₂ is needed to determine the dissolved oxygen content, an estimated pO₂ was calculated. Under standard conditions (T=37° C., pH=7.4, and pCO₂=40 mmHg), the relationship between pO₂ and SO₂ is well described by the oxyhemoglobin dissociation curve (ODC). It is thus possible to use SO₂ to calculate pO₂ with the aid of empirically derived algorithms based upon the ODC. For clarity, we denote the thus-obtained value as (pO₂)° _{c} where the subscript denotes that it is calculated and the superscript denotes that it is at physiological “standard state” (T=37° C., pH=7.4, and pCO₂=40 mmHg). Since the ODC changes heavily upon deviation from physiological conditions, the pO₂ calculated must be adjusted for changes in temperature, pH, and pCO₂ using an appropriate model. The Severinghaus model was chosen due to its good agreement with pO₂ values for certain samples that were above the detection limit of the blood gas instrument. The equation used is Severinghaus' empirical modification of Hill's equation, given by:

(pO₂)° _{c}=e^{0.385 ln(S}^{^{−1}}^{-1)+3.32-(72S)}^{^{−1}}^{-0.175S}^{^{−6}} (23)

Here, S=SO₂₌(FO₂Hb)/(FO₂Hb+FHHb), expressed as a fraction between 0 and 1. To convert each (pO₂)° _{c} to a (pO₂)_{c} at each given pH, T, and pCO₂, Kelman's equation was used:

(pO₂)_{c}=(pO₂)° _{c}*10^{-(0.024(37-T)+0.40(pH-7.0)+0.06(log(40)-log(pCO}^{₂}⁾⁾⁾ (24)

Where T is the temperature in ° C. and pCO₂ is the CO₂ partial pressure in mmHg. For samples where the pCO₂ was below detection limit, the pCO₂ correction term was omitted. Furthermore, it should be noted that even the largest ΔpO₂ possible in our calculations (assuming the true pO₂ was far below the detection limit near 0) would only lead to a 1-2% deviation in the calculated amount of O₂ delivered.

For each calculation of the amount of O₂ released, a background correction was also applied based on nitrogenated control experiments for analogous aqueous solutions. Upon determining an average O₂ background, this value was then subtracted from the average O₂ delivered at each dose (50, 100, or 150 μL) to obtain the final value for the average O₂ delivered at that dose. The nitrogen controls displayed minimal O₂ backgrounds (3% average increase in FO₂Hb for silicalite-1, and 5% average increase in FO₂Hb for (mPEG)ZIF-8). Among all measurements, only the oxygenated nanocrystal dispersions displayed linear correlations between the measured O₂ delivered and the injection dose; both the nitrogenated controls did not show linear correlations as expected. Furthermore, the average O₂ carrying capacity (4 mL/dL) of the 5% dextrose dispersion was very close to the theoretical value (approximately 3 mL/dL).

To obtain an average O₂ carrying capacity for each of the dispersions, the dose volume in μL was plotted versus the average volume of O₂ delivered in μL for each of the three doses. The slope of the linear best-fit line for each dispersion, multiplied by 100, yielded the calculated O₂ carrying capacity in mL/dL.

### Calculating Extent of mPEG Surface Functionalization and Grafting Density

To calculate the extent of surface functionalization with mPEG, ZIF-8 nanocrystals were approximated as spheres. Given the size of the nanocrystal and the dimensions of the unit cell, the number of unit cells at the surface was calculated as:

$${N}_{surface} = \frac{S {A}_{n c}}{{A}_{unit cell}} \qquad ( 25 )$$

where N_{surface} is the number of unit cells at the surface of the bulk nanocrystal, SA_{nc} is the surface area of the nanocrystal, and A_{unit cell} is the area for a single face of the ZIF-8 unit cell.

From the number of unit cells at the surface, the total number of surface mIm linkers were obtained as:

mIm_{surface}=N_{surface}×mIm_{single unit cell} (26)

where mIm_{surface} is the number of surface-terminating mIm linkers and mIm_{single unit cell} is the number of surface-terminating mIm linkers in a single unit cell obtained from the crystal structure of ZIF-8.

For surface-selective functionalization, the maximum theoretical number of mPEG ligands at the surface should be equivalent to mIm_{surface}. Thus, the extent of surface functionalization can be calculated as:

$$\% functionalization = \frac{\% mPEG}{\% {mIm}_{surface}} \qquad ( 27 )$$

where % mPEG is the % mPEG ligand relative to that of the mIm linker present based on digestion NMR (FIG. 26), and % mIm_{surface} is the % surface-terminating mIm linker relative to that of the total mIm linker calculated based on the size of the nanocrystal.

From the extent of functionalization, the number of mPEG ligands present in a single nanocrystal can be calculated by multiplying mIm_{surface} by % functionalization. The surface grafting density can then be calculated as:

$$grafting density = \frac{{N}_{m P E G}}{S {A}_{nc}} \qquad ( 28 )$$

where N_{mPEG} is the number of mPEG ligands grafted to a single nanocrystal.

### Theoretical Density Calculations

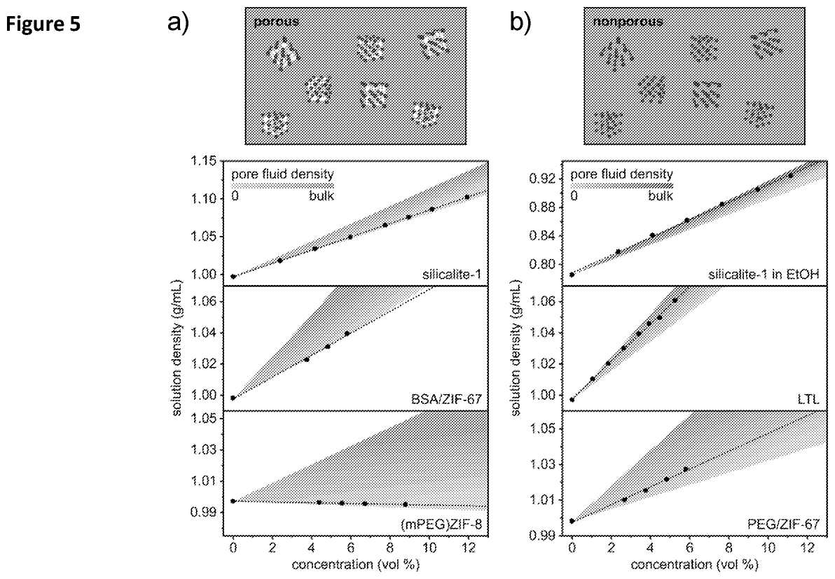

Theoretical solution densities were calculated in order to compare to experimental values (FIGS. 5a-5b and FIGS. 8a-8u). The solution density is the sum of 3 individual mass-per-volume concentrations: 1) bulk fluid outside the pores, 2) porous nanoparticles, and 3) fluid inside the nanocrystal pores. Specifically,

ρₛₒₗᵤₜᵢₒₙ=ρ_{fluid,bulk}(1−cₙₚ)+ρₙₚcₙₚ+ρ_{fluid,pore}Vₚₒᵣₑρₙₚcₙₚ (29)

where ρₛₒₗᵤₜᵢₒₙ is the solution density in g/mL, ρ_{fluid,bulk} is the density of the bulk fluid (e.g. water or 5% dextrose solution), cₙₚ is the volumetric concentration of the nanoparticle solution, ρₙₚ is the crystallographic density of the nanoparticle, ρ_{fluid,pore} is the density of the fluid inside the pores, and Vₚₒᵣₑ is the pore volume. Note that the crystallographic density of the nanoparticle must be used in order to account for both the volume occupied by the nanoparticle framework and the volume occupied by the pores. The crystallographic densities of each material are listed in Table 1. The concentration of nanoparticle in solution (cₙₚ) is calculated as described above. Lastly, the pore volume (Vₚₒᵣₑ) was obtained from a t-plot analysis of BET isotherms for each material (FIGS. 12a-12d).

For PEG/ZIF-67 and BSA/ZIF-67 solutions, the density of aqueous PEG or BSA solutions at the relevant concentration was used as ρ_{fluid,bulk}. The relevant concentration of the aqueous PEG solution was calculated per total volume of colloidal solution because PEG is sterically capable of accessing the entire pore volume of the nanocrystal, while the relevant concentration of the aqueous BSA solution was calculated per volume of water because BSA is too sterically restricted to access the internal pore volume.

### Internal and External Surface Area in the Solid State

Solid-state adsorption measurements of nanocrystalline powders include contributions from adsorption in the internal pores of a sample, as well as on external surfaces and interparticle voids. We assessed the relative amount of external surface area in our samples via the t-plot method for P/P₀>0.3 using the Harkins and Jura thickness curves (FIG. 12a-12e). For silicalite-1, we also validated this analysis by calculating the external surface area of a non-calcined sample, which has no internal porosity (FIG. 12e). Both the t-plot method and the comparison of calcined vs. non-calcined samples indicate that 16-18% of the total measured surface area in the solid state is due to external surfaces that would be covered by water in aqueous solution.

### Example 2

To create uniform, stable dispersions of silicalite-1 in water and to determine if any permanent porosity is present, we first optimized synthesis, purification, and calcination conditions to form nanocrystals of similar size (average diameter=60±X nm or 90±16 nm) (FIG. 16b) and to remove structure-directing tetrapropylammonium cations from the zeolite pores without irreversibly aggregating the particles in the solid state. The resulting silicalite-1 nanocrystals yielded translucent aqueous colloidal solutions that were exceptionally stable (FIG. 15a), with no settling or aggregation observed over the course of at least several weeks (FIGS. 4e and 15a). Moreover, colloidal stability was not impacted by degassing the solutions under vacuum. If the porous networks of the silicalite-1 nanocrystals in these solutions do not contain water, the most concentrated colloidal solution would be 8.3% porous.

Since the volume occupied by a porous liquid with dry (e.g., gas-, e.g., air-filled) pores will be larger than the volume occupied by an equivalent nonporous liquid with wet (solvent-filled) pores, density measurements were used as an initial probe of the hydration status of silicalite-1 pores in aqueous dispersions. Surprisingly, experimental densities across a wide range of silicalite-1 concentrations are within 0.5% of the values predicted for dry pores at 15, 25, and 37° C. (FIGS. 5a and 8a-8f). This is in contrast to dispersions of silicalite-1 in ethanol—where intrusion of the less polar solvent molecules should be thermodynamically favored at ambient pressure—and of the hydrophilic zeolite LTL in water—where water intrusion into the more polar aluminosilicate pores should also be thermodynamically favored under ambient conditions—which both have densities consistent with nonporous liquids containing solvent-filled pores (FIGS. 5b and 8g-8l). Note that the density of solvent within a porous network can be as much as 40% lower than the bulk liquid density due to confinement effects.

For a porous liquid to be useful for gas storage and transport applications, the pore networks need to be not only dry but also capable of reversibly adsorbing and releasing gas molecules. To directly probe the gas accessibility of pores within aqueous dispersions of silicalite-1 nanocrystals, the amount of O₂ and CO₂ absorbed in degassed solutions was measured. At 25° C., the gas absorption capacity of a 12 vol % (20 wt %) solution of silicalite-1 nanocrystals was 26 mmol 02/L at 0.84 bar and 284 mmol COWL at 0.67 bar, which is over an order of magnitude more than the 1.1 mmol/L of O₂ and 23 mmol/L of CO₂ absorbed in water under the same conditions (FIGS. 6a and 6b, respectively). Moreover, these gas capacities are 88% and 86%, respectively, of the O₂ and CO₂ capacities predicted by assuming that solution absorption is equivalent to the sum of the pure-water gas solubility and the adsorption capacity of silicalite-1 nanocrystals in the solid state (FIG. 6c, see also see FIGS. 11a, 11b, 21a, 21b, 23a, 23b, and Table 6). Since the solid-state gas capacity measured for nanocrystalline powders will also include contributions from gas adsorption at external surfaces and in interparticle voids that will not be present in solution these gas capacities are consistent with dry porous networks in liquid water that are fully accessible to gas molecules. Solid state N₂ adsorption isotherms at 25° C. for silicalite-1 are shown in FIGS. 22a-22b. Vol % concentrations of silicalite-1 and LTL zeolite were determined as described in Table 3.

Cycling experiments confirm that gas absorption is fully reversible upon degassing (FIG. 13). In addition, gas release can be directly quantified by measuring the change in dissolved O₂ when a gas-loaded solution is added to pure, degassed water (see FIG. 7a). For example, when an oxygenated silicalite-1 dispersion is injected into deoxygenated water, a partial pressure gradient is established that drives the release of adsorbed O₂ from the silicalite-1 nanocrystals into bulk water until a new equilibrium is established once the partial pressures of dissolved and adsorbed O₂ are equal. Consistent with the absorption experiments, oxygenated silicalite-1 solutions deliver up to 89% of their predicted O₂ capacity to deoxygenated water (see FIG. 7b). Moreover, the amount of dissolved O₂ equilibrates within seconds after injection of a silicalite-1 dispersion, which demonstrates the rapid O₂ release kinetics of these porous liquids. In contrast to silicalite-1, the amount of O₂ and CO₂ absorbed in an aqueous dispersion of zeolite LTL nanocrystals is nearly identical to pure water and corresponds to about 0% of the zeolite capacity predicted for dry pores (FIG. 7b). These results emphasize the importance of hydrophobic pores and permanent porosity to achieving high gas capacities in water.

### Example 3

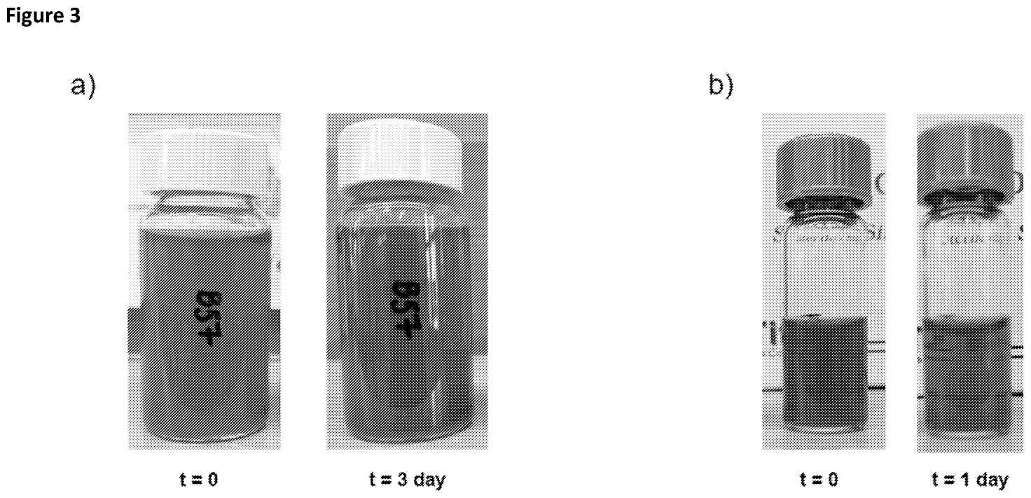

PEG (Mₙ=35,000 g/mol) at 30 wt % in water can disperse 20 wt % (21 vol %) of ZIF-8 (average size=91±8 nm) and 7.0 wt % (7.4 vol %) of ZIF-67 (average size=780±14 nm) without observable aggregation (FIGS. 2a-2b and 3a-3b). Furthermore, ZIF-8 remains crystalline when associated with PEG in water for at least 5 weeks, and PEG increases the hydrolytic stability of ZIF-67, which otherwise rapidly degrades in water (FIGS. 15d-15e). However, the O₂ capacities of the aqueous PEG dispersions of ZIF-8 and ZIF-67 are less than 11% of the theoretical capacities (FIG. 7b). Along with density measurements (FIG. 5b), this limited O₂ capacity suggests that these aqueous solutions are not porous because of PEG intrusion into the ZIF pores. Given that PEG is a compact, flexible polymer and is amphiphilic, there does not appear to be a strong enough driving force to prevent its intrusion by either sterics or thermodynamics—an effect that has been observed in the solid state for PEG with other metal—organic frameworks. DLS measurements of colloidal solutions of PEG/ZIF-8 and PEG/ZIF-67 in water are shown in FIGS. 25a-25b.

Mixing BSA (10 wt %) with ZIF-67 nanocrystals (3.8 wt %) enables complete dispersion of ZIF-67 in water with no observable precipitation over a period of at least 4 days (FIGS. 8f, 15d-15e, and 16g). Density measurements on BSA/ZIF-67 dispersions are consistent with air-filled pores (FIG. 5a). Moreover, when oxygenated BSA/ZIF-67 dispersions are injected into deoxygenated water, the measured O₂ capacity approaches 80%±9% of the theoretical capacity obtained by assuming all ZIF-67 pores are empty and accessible to gas (FIG. 7b). Furthermore, the O₂ capacity of the BSA/ZIF-67 dispersion does not change after 4 days in water, as the adsorbed BSA corona presumably protects ZIF-67 from hydrolytic degradation via surface passivation. Similar O₂ capacities are also obtained for BSA/ZIF-8 dispersions (Table 17). Thus, non-covalent protein adsorption successfully extends the porous water concept to hydrophobic MOFs.

ZIF-8 nanocrystals were reacted with methoxypolyethylene epoxide (mPEG; Mₙ=750 g/mol for PEG). The formation of the expected covalent linkage between ring-opened epoxide and mIm was confirmed by mass spectrometry (FIG. 27), with NMR digestion experiments indicating that approximately 14% of the mIm surface ligands are functionalized with mPEG (FIG. 26). Importantly, this grafting density (1.2 ligands per nm²) was sufficient to stabilize colloidal dispersions of ZIF-8 in water at up to 8.3 vol % (7.0 wt %), with minimal precipitation or aggregation over the course of at least 5 days (FIGS. 8e and 15b). In contrast to ZIF-8 nanocrystals non-covalently functionalized with PEG, the solution density as a function of concentration is consistent with that expected for a porous liquid containing air-filled pores (FIG. 5a), and the measured O₂ release upon injection of an oxygenated dispersion into deoxygenated water is 96%±7% of the theoretical capacity (FIG. 7b). This demonstrates that localization of short hydrophilic ligands on the surface of hydrophilic MOF nanocrystals can impart dispersibility in water while maintaining permanent porosity and a high gas absorption capacity. Solid-state adsorption isotherms for ZIF-8 nanocrystals before and after functionalization with mPEG (FIGS. 24a-24c), show that covalent functionalization has a negligible impact on the adsorption of O₂ and N₂ near ambient temperature.

### Example 4

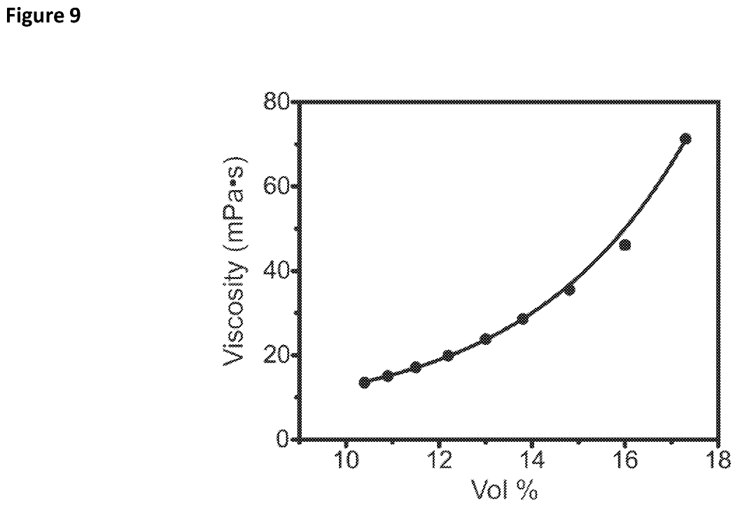

Nanocrystals of the zeolite ZSM-5—which is the isostructural aluminosilicate analogue of silicalite-1—have more hydrophilic external surfaces than silicalite-1 nanocrystals (FIG. 10b) and can form aqueous solutions at a concentration as high as 39 vol % (FIG. 15c) with a viscosity of only 57 cP at 25° C. for a 39 vol % solution (see silicalite-1 viscosity vs vol % in FIG. 9). At a high Si:Al ratio of 64, density measurements indicate that the pores of ZSM-5 nanocrystals (average diameter=238±23 nm) (FIG. 16d) are hydrophobic enough to prevent water intrusion and form a porous solution (FIG. 8s-8u). As a result, our 39 vol % solution of ZSM-5 nanocrystals has an extremely high O₂ carrying capacity of 187±18 mL/dL that far exceeds the capacity of any other natural or synthetic aqueous O₂ carrier (FIG. 7c).

As an initial exploration of whether the high O₂ capacities of these porous liquids could be translated to more biomedically relevant environments than pure water, we performed ex vivo experiments to test the delivery of O₂ to deoxygenated donated human blood. Importantly, density measurements confirm that the permanent porosity of aqueous silicalite-1 and (mPEG)ZIF-8 dispersions is maintained in a 5% dextrose solution (FIGS. 8d-8f and 8p-8r), which is isotonic to red blood cells (RBCs). The O₂ carrying capacity of these solutions can be extracted from measurement of the change in oxyhemoglobin concentration upon addition of different volumes of solution to deoxygenated RBCs. Notably, oxygenated solutions of 90-nm silicalite-1 nanocrystals (10.8 vol %), 60-nm silicalite-1 nanocrystals (9.1 vol %), and (mPEG)ZIF-8 (6.7 vol %) in 5% dextrose rapidly release O₂ after injection into RBCs—with the amount of O₂ released increasing linearly in a dose-dependent manner—yielding O₂ carrying capacities that are in excellent agreement with the values predicted from adsorption measurements and O₂ release experiments in pure water (FIGS. 7d and 20a-20b). Additionally, more concentrated silicalite-1 dispersions were capable of delivering 110 mL/dL of O₂ to RBCs—well above the density of bulk O₂ gas.

### Example 5

The following tables provide further characteristics of the compositions of the invention.

TABLE 1
Crystallographic densities.

| | Crystallographic |
|---|---|
| | Density |
| Material | (g/mL) |
| silicalite-1 | 1.858 |
| ZSM-5 (Si/Al = 64) | 1.880 |
| LTL | 1.959 |
| ZIF-8 | 0.95 |
| ZIF-67 | 0.947 |

TABLE 2
Weight % remaining as a function of temperature determined
by TGA for zeolite samples. Samples were dropcast into TGA
pans and dried in air before beginning the TGA run. The drop
in mass corresponds to the amount of re-adsorbed water in the
zeolite, which was taken into account when determining the
concentrations of aqueous solutions by TGA or manual drying
and weighing.

| | Temperature | Wt % |
|---|---|---|
| Material | (° C.) | remaining |
| silicalite-1 (90 nm) | 150 | 97.3110 |
| | 200 | 97.2128 |
| | 250 | 97.1162 |
| silicalite-1 (60 nm) | 150 | 95.2452 |
| | 200 | 95.1167 |
| | 250 | 95.0153 |
| LTL | 150 | 86.3378 |
| | 200 | 85.9571 |
| | 250 | 85.8689 |
| ZSM-5 (Si/Al = 64) | 150 | 94.9425 |
| | 200 | 94.7085 |
| | 250 | 94.5540 |

TABLE 3
Zeolite solution concentrations for samples used in
absorption isotherm measurements were determined
by ICP, TGA, and manual dryingand weighing,
which all give consistent results.

| | | Concen- | Concen- | Concentration |
|---|---|---|---|---|
| | | tration | tration | from manual |
| | | from ICP | from TGA | weighing |
| Material | Sample | (vol %) | (vol %) | (vol %) |
| silicalite-1 | before absorption | 12.0 | 11.9 | 11.98 |
| (90 nm) | experiments | | | |
| | after absorption | 11.8 | | |
| | experiments | | | |
| | before cycling | 9.67 | 9.05 | 9.830 |
| | absorption | | | |
| | experiments | | | |
| | after cycling | 9.83 | | 9.736 |
| | absorption | | | |
| | experiments | | | |
| LTL | before absorption | 5.27 | 4.78 | 5.367 |
| | experiments | | | |
| | after absorption | 4.82 | | 5.034 |
| | experiments | | | |

TABLE 4
Summary of BET surface areas and pore volumes for materials
studied in this work obtained from 77K N₂ adsorption isotherms.

| | BET | Pore |
|---|---|---|
| | surface | volume |
| | area | at P/P₀ = 0.1 |
| Material | (m²/g) | (mL/g) |
| silicalite-1 | 457.2 | 0.18 |
| LTL | 512.9 | 0.21 |
| ZIF-8 | 1749 | 0.67 |
| (mPEG)ZIF-8 | 1674 | 0.65 |
| ZIF-67 | 1768 | 0.68 |

TABLE 5
Summary of linear fits to solid-state O₂ and N₂ adsorption data and Henry's law constants used ins
calculations of theoretical solution capacities. Henry's constants in mmol/L · mbar are calculated
using the crystallographic density of the material (Table 1).

| | T | | Slope | Intercept | Henry's constant |
|---|---|---|---|---|---|
| Material | (° C.) | Gas | (mmol/g · mbar) | (mmol/g) | (mmol/L · mbar) |
| silicalite-1 | 15 | O₂ | 2.016 × 10⁻⁴ | 0.0019 | 0.3705 |
| (calcined) | 25 | O₂ | 1.656 × 10⁻⁴ | 0.0017 | 0.3044 |
| | 37 | O₂ | 1.329 × 10⁻⁴ | 8.216 × 10⁻⁴ | 0.2443 |
| | 25 | N₂ | 1.804 × 10⁻⁴ | 0.00168 | 0.3316 |
| silicalite-1 | 25 | O₂ | 8.408 × 10⁻⁶ | −5.884 × 10⁻⁴ | 0.0155 |
| (non-calcined) | | | | | |
| LTL | 15 | O₂ | 8.937 × 10⁻⁵ | −6.131 × 10⁻⁵ | 0.1751 |
| | 25 | O₂ | 7.464 × 10⁻⁵ | 2.151 × 10⁻⁴ | 0.1462 |
| | 37 | O₂ | 6.174 × 10⁻⁵ | −2.862 × 10⁻⁴ | 0.1209 |
| | 25 | N₂ | 1.286 × 10⁻⁴ | 8.276 × 10⁻⁴ | 0.2519 |
| ZIF-8 | 15 | O₂ | 1.215 × 10⁻⁴ | −3.682 × 10⁻⁴ | 0.1154 |
| | 25 | O₂ | 1.054 × 10⁻⁴ | −3.448 × 10⁻⁴ | 0.1001 |
| | 37 | O₂ | 8.659 × 10⁻⁵ | −6.832 × 10⁻⁵ | 0.0823 |
| | 25 | N₂ | 9.925 × 10⁻⁵ | −4.665 × 10⁻⁴ | 0.0943 |
| (mPEG)ZIF-8 | 15 | O₂ | 1.188 × 10⁻⁴ | −5.430 × 10⁻⁴ | 0.1129 |
| | 25 | O₂ | 1.030 × 10⁻⁴ | −4.675 × 10⁻⁴ | 0.0979 |
| | 37 | O₂ | 8.352 × 10⁻⁵ | −1.001 × 10⁻⁴ | 0.0793 |
| | 25 | N₂ | 9.633 × 10⁻⁵ | −7.348 × 10⁻⁴ | 0.0915 |
| ZIF-67 | 25 | O₂ | 1.131 × 10⁻⁴ | −7.942 × 10⁻⁴ | 0.1074 |
| | 25 | N₂ | 1.032 × 10⁻⁴ | −4.380 × 10⁻⁴ | 0.0980 |
| ZSM-5 | 25 | O₂ | 1.685 × 10⁻⁴ | 0.00264 | 0.3116 |

TABLE 6
Summary of single site Langmuir-Freundlich fits to solid-state CO₂
adsorption data at 25° C., where qₛₐₜ is the saturation capacity (mmol/g),
b is the Langmuir parameter (bar^{-v}), v is the Freundlich parameter
(dimensionless), P is pressure (bar), and n is the amount adsorbed
$( mmol / g ) with n = \frac{{q}_{sat} {bP}^{v}}{1 + b {P}^{v}} .$

| Material | T (° C.) | Gas | qₛₐₜ | b | v |
|---|---|---|---|---|---|
| silicalite-1 | 25 | CO₂ | 3.382 | 1.026 | 1.020 |
| (calcined) | | | | | |
| silicalite-1 (non- | 25 | CO₂ | 9.408 | 4.263 × 10⁻⁵ | 0.7707 |
| calcined) | | | | | |
| LTL | 25 | CO₂ | 3.383 | 3.926 | 0.7682 |

TABLE 7
Henry's law constants for pure O₂ and CO₂ solubility
in water used in this work.

| | T | | Henry's constant | |
|---|---|---|---|---|
| Material | (° C.) | Gas | (mmol/L · mbar) | Reference |
| water | 15 | O₂ | 0.00153 | Error! |
| | | | | Bookmark |
| | | | | not defined. |
| | 25 | O₂ | 0.00127 | Error! |
| | | | | Bookmark |
| | | | | not defined. |
| | 37 | O₂ | 0.00107 | Error! |
| | | | | Bookmark |
| | | | | not defined. |
| | 25 | CO₂ | 0.03385 | Error! |
| | | | | Bookmark |
| | | | | not defined. |

TABLE 8
Comparison of adsorption capacity at 1 bar and 25° C.
on a gravimetric basis for silicalite-1 and water.

| | | Adsorption capacity |
|---|---|---|
| | | at 1 bar, 25° C. |
| Material | Gas | (mmol/g) |
| silicalite-1 | O₂ | 0.166 |
| | CO₂ | 1.71 |
| water | O₂ | 1.27 × 10⁻³ |
| | CO₂ | 3.37 × 10⁻³ |

TABLE 9
Experimental and expected gas absorption values for pure-water
control experiments. All values are an average of three separate
doses at equivalent pressures. The difference between experimental
and expected is within the accuracy of the measurement.

| | | | Experimental | Expected | Standard |
|---|---|---|---|---|---|
| | T | Pressure | Solubility | Solubility | deviation |
| Gas | (° C.) | (bar) | (mmol/L) | (mmol/L) | (mmol/L) |
| O₂ | 25 | 419.5 | −0.20 | 0.53 | ±0.321 |
| CO₂ | 25 | 395.9 | 12.5 | 13.4 | ±0.0416 |

TABLE 10
| Data recorded for three injections of oxygenated aqueous
solutions of ZSM-5 nanocrystals (39.0
vol %) into deoxygenated water. Each injection was into
a fresh vial of deoxygenated water, and the cO₂ final
values were corrected for differences in measurement
and calibration temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 13.5 | 1.282 | 0.39 | 18.11 | 206 | 76.0 |
| 2 | 18.0 | 1.282 | 0.46 | 20.16 | 186 | 73.6 |
| 3 | 16.0 | 1.282 | 0.34 | 17.92 | 170 | 69.1 |

TABLE 11
| Data recorded for three injections of oxygenated aqueous
solutions of 90-nm silicalite-1 nanocrystals (12.5 vol %) into
deoxygenated water. Each injection was done into a fresh vial of
deoxygenated water, and the cO₂ final values were corrected
for differences in measurement and calibration
temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 14.0 | 1.282 | 0.77 | 11.60 | 95.0 | 92.8 |
| 2 | 24.0 | 1.282 | 0.57 | 14.54 | 78.1 | 80.8 |
| 3 | 17.0 | 1.282 | 0.84 | 13.32 | 94.4 | 92.2 |

TABLE 12
| Data recorded for three injections of oxygenated
aqueous solutions of 90-nm silicalite-1
nanocrystals (3.6 vol %). Each injection was done into a
fresh vial of deoxygenated water, and the cO₂ final
values were corrected for differences in measurement
and calibration temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 45 | 1.239 | 0.12 | 10.21 | 24.7 | 79.1 |
| 2 | 40 | 1.239 | 0.23 | 8.44 | 21.6 | 69.5 |
| 3 | 40 | 1.239 | 0.13 | 8.71 | 22.5 | 72.3 |

TABLE 13
| Data recorded for five injections of oxygenated aqueous
solutions of (mPEG)ZIF-8 nanocrystals
(6.6 vol %). Injections 1 and 3 were done in fresh vials
of deoxygenated water, while injection 2 was done in
the same vial as injection 1, and injections 4 and 5 were
done in the same vial as injection 3. The cO₂ final
values were corrected for differences in measurement
and calibration temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 60 | 1.196 | 0.41 | 11.49 | 19.6 | 100% |
| 2 | 72.5 | 1.196 | 11.49 | 18.78 | 16.9 | 85.3% |
| 3 | 35 | 1.189 | 0.62 | 7.74 | 19.8 | 102% |
| 4 | 22.5 | 1.189 | 7.74 | 11.24 | 19.5 | 99.9% |
| 5 | 32.5 | 1.189 | 11.24 | 15.06 | 17.9 | 90.4% |

TABLE 14
| Data recorded for three injections of oxygenated
aqueous solutions of BSA/ZIF-67 (3.6 vol %).
Each injection was done into a fresh vial of deoxygenated
water, and the cO₂ final values were corrected for
differences in measurement and calibration
temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 102.5 | 1.239 | 0.48 | 9.21 | 8.9 | 70.7 |
| 2 | 102.5 | 1.239 | 0.33 | 10.37 | 10.6 | 86.5 |
| 3 | 52.5 | 1.239 | 0.61 | 6.11 | 10.4 | 84.1 |

TABLE 15
| Data recorded for three injections of air-equilibrated
PEG/ZIF-8 solutions (3.6 vol %). Injections 1
and 3 were done into fresh vials of deoxygenated water,
while injection 2 was done into the same vial as
injection 1. The cO₂ final values were corrected for differences
in measurement and calibration temperature
as described above, with the initial cO₂ of injection 2 taken
as the final, post-correction cO₂ of injection 1.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 100 | 1.154 | 0.08 | 0.87 | 0.9 | 5.0 |
| 2 | 100 | 1.154 | 0.87 | 1.59 | 0.9 | 4.8 |
| 3 | 100 | 1.174 | 0.21 | 1.06 | 1.3 | 10.0 |

TABLE 16
| Data recorded for three injections of air-equilibrated
PEG/ZIF-67 (3.6 vol %) solutions. Injections 1
was done into a fresh vial of deoxygenated water, while
injection 2 and 3 was done into the same vial as
injection 1. The cO₂ final values were corrected for
differences in measurement and calibration temperature
as described above, with the initial cO₂ of injections
2 and 3 taken as the final, post-correction cO₂ of
injection 1 and 2, respectively.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 100 | 1.187 | 0.28 | 1.06 | 1.2 | 7.9 |
| 2 | 100 | 1.187 | 1.06 | 1.86 | 1.7 | 13.3 |
| 3 | 100 | 1.187 | 1.87 | 2.54 | 1.4 | 9.8 |

TABLE 17
| Data recorded for three injections of oxygenated
aqueous solutions of zeolite LTL nanocrystals
(4.8 vol %) equilibrated at 1 bar O₂. Each injection was
done into a fresh vial, and the cO₂ final values were
corrected for differences in measurement and
calibration temperature as described above.

| | Injected | Vial | cO₂ | cO₂ | O₂ carrying | % of |
|---|---|---|---|---|---|---|
| | volume | volume | initial | final | capacity | theoretical |
| Trial | (μL) | (mL) | (mg/L) | (mg/L) | (mL/dL) | capacity |
| 1 | 155 | 1.181 | 0.17 | 5.36 | 2.7 | −5.7 |
| 2 | 155 | 1.154 | 0.64 | 6.26 | 2.9 | −1.4 |
| 3 | 150 | 1.181 | 0.61 | 5.57 | 2.7 | −5.5 |

TABLE 18
Data recorded for three control injections of nitrogenated aqueous
solutions of ZSM-5 (36 vol %). Each injection was done into a fresh
vial of deoxygenated water, and negligible changes in the initial and
final O₂ concentrations were observed. Note that temperature corrections
were not applied to the initial and final cO₂ values.

| | Injected | Vial | cO₂ | cO₂ |
|---|---|---|---|---|
| | volume | volume | initial | final |
| Trial | (PL) | (mL) | (mg/L) | (mg/L) |
| 1 | 19.0 | 1.282 | 1.24 | 1.18 |
| 2 | 14.0 | 1.190 | 0.88 | 1.00 |
| 3 | 17.0 | 1.282 | 0.86 | 0.85 |

TABLE 19
| Summary of ABG results following injection of
various volumes of oxygenated aqueous solutions
of 90-nm silicalite-1 nanocrystals (10.8 vol %). BL-1
corresponds to the baseline (pre-injection) values for the
blood before each of the 50, 100, and 150 μL injections,
while BL-2 corresponds to the baseline values for
the blood before each of the 200 μL injections. A value that is
below the detection limit for that parameter on
the ABG is denoted by a < followed by the upper bound
of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 7.177 | 38.9 | <30.1 | 6.8 | 7.8% | 86.8% |
| BL-2 | 0 | 7.149 | 39.4 | <30.1 | 7.2 | 8.6% | 85.7% |
| 1 | 50 | 7.088 | 42.1 | <30.1 | 6.6 | 29.1% | 65.6% |
| 2 | 50 | 7.084 | 43.1 | <30.1 | 6.8 | 27.2% | 67.7% |
| 3 | 50 | 7.088 | 42.4 | <30.1 | 6.8 | 27.0% | 67.9% |
| 4 | 100 | 7.082 | 40.6 | <30.1 | 6.5 | 45.3% | 49.3% |
| 5 | 100 | 7.080 | 41.1 | <30.1 | 6.6 | 43.2% | 51.3% |
| 6 | 100 | 7.079 | 41.1 | <30.1 | 6.6 | 43.7% | 50.8% |
| 7 | 150 | 7.069 | 40.4 | <30.1 | 6.4 | 56.5% | 38.2% |
| 8 | 150 | 7.064 | 39.7 | <30.1 | 6.4 | 68.0% | 26.7% |
| 9 | 150 | 7.065 | 39.8 | <30.1 | 6.4 | 67.0% | 27.8% |
| 10 | 200 | 7.068 | 39.2 | 31.3 | 6.5 | 74.4% | 20.6% |
| 11 | 200 | 7.066 | 39.1 | 35.2 | 6.5 | 79.1% | 16.0% |
| 12 | 200 | 7.066 | 39.1 | 33.6 | 6.5 | 77.3% | 17.7% |

TABLE 20
| Summary of ABG results following injection of
various volumes of nitrogenated aqueous solutions
of 90-nm silicalite-1 nanocrystals (10.8 vol %). BL-1,2
corresponds to the baseline (pre-injection) values for
trials 1 and 2, while BL-3-9 corresponds to the baseline
for trials 3 through 9. A value that is below the
detection limit for that parameter on the ABG is denoted
by a < followed by the upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1,2 | 0 | 7.481 | 38.5 | 132 | 6.9 | 7.7% | 90.9% |
| BL-3-9 | 0 | 7.352 | 38.5 | <30.1 | 7.1 | 9.1% | 89.5% |
| 1 | 50 | 7.342 | 38.5 | <30.1 | 6.9 | 10.2% | 88.1% |
| 2 | 50 | 7.342 | 38.4 | <30.1 | 6.9 | 11.0% | 87.1% |
| 3 | 50 | 7.344 | 37.5 | <30.1 | 6.9 | 11.3% | 86.9% |
| 4 | 100 | 7.351 | 35.7 | <30.1 | 7.0 | 9.9% | 88.4% |
| 5 | 100 | 7.348 | 35.6 | <30.1 | 6.6 | 12.0% | 86.1% |
| 6 | 100 | 7.348 | 35.7 | <30.1 | 6.6 | 12.6% | 85.6% |
| 7 | 150 | 7.344 | 34.7 | <30.1 | 7.0 | 12.3% | 85.8% |
| 8 | 150 | 7.341 | 34.8 | <30.1 | 7.4 | 11.3% | 86.9% |
| 9 | 150 | 7.341 | 34.9 | <30.1 | 7.5 | 12.1% | 86.1% |

TABLE 21
| Summary of ABG results following injection of various
volumes of oxygenated aqueous solutions
of 60-nm silicalite-1 nanocrystals (9.1 vol %). BL-1, BL-2,
and BL-3 correspond to the baseline (pre-injection)
values for the blood before the 50, 100, and 150 μL
injections, respectively. A value that is below the
detection limit for that parameter on the ABG is denoted
by a < followed by the upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 7.097 | 41.3 | <30.1 | 6.4 | 6.1% | 88.9% |
| BL-2 | 0 | 7.09 | 42.8 | <30.1 | 6.5 | 4.9% | 90.1% |
| BL-3 | 0 | 7.093 | 41.8 | <30.1 | 6.3 | <3.3% | 93.4% |
| 1 | 50 | 7.065 | 41.8 | <30.1 | 6.4 | 24.0% | 71.0% |
| 2 | 50 | 7.069 | 41.9 | <30.1 | 6.4 | 23.2% | 72.1% |
| 3 | 50 | 7.066 | 41.9 | <30.1 | 6.4 | 27.5% | 67.6% |
| 4 | 100 | 7.038 | 43.1 | <30.1 | 6.2 | 40.8% | 54.4% |
| 5 | 100 | 7.046 | 42.9 | <30.1 | 6.3 | 31.8% | 63.5% |
| 6 | 100 | 7.045 | 41.4 | <30.1 | 6.4 | 45.7% | 49.5% |
| 7 | 150 | 7.016 | 41.9 | <30.1 | 6.0 | 52.3% | 43.3% |
| 8 | 150 | 7.025 | 42.2 | <30.1 | 5.9 | 47.6% | 47.9% |
| 9 | 150 | 7.009 | 41.9 | <30.1 | 5.8 | 56.9% | 38.8% |

TABLE 22
| Summary of ABG results following injection of
various volumes of oxygenated aqueous solutions
of (mPEG)ZIF-8 nanocrystals (6.6 vol %). BL-1
corresponds to the baseline (pre-injection) values for the
blood before each of the 50, 100, and 150 μL injections.
A value that is below the detection limit for that
parameter on the ABG is denoted by a < followed
by the upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 6.978 | 39.9 | <30.1 | 3.8 | 12.6% | 84.7% |
| 1 | 50 | 7.703 | <15.4 | <30.1 | 3.7 | 25.9% | 70.6% |
| 2 | 50 | 7.723 | <15.4 | <30.1 | 3.7 | 27.6% | 69.3% |
| 3 | 50 | 7.736 | <15.4 | <30.1 | 3.7 | 26.6% | 69.8% |
| 4 | 100 | 7.664 | <15.4 | <30.1 | 3.6 | 34.1% | 61.8% |
| 5 | 100 | 7.698 | <15.4 | <30.1 | 3.5 | 36.6% | 59.3% |
| 6 | 100 | 7.636 | <15.4 | <30.1 | 3.6 | 35.0% | 60.9% |
| 7 | 150 | 7.726 | <15.4 | <30.1 | 3.5 | 47.1% | 48.2% |
| 8 | 150 | 7.712 | <15.4 | <30.1 | 3.5 | 45.1% | 50.6% |
| 9 | 150 | 7.697 | <15.4 | <30.1 | 3.5 | 42.1% | 53.6% |

TABLE 23
| Summary of ABG results following injection of
various volumes of nitrogenated aqueous solutions
of (mPEG)ZIF-8 nanocrystals (6.6 vol %). BL-1 corresponds
to the baseline (pre-injection) values for the
blood before each of the 50, 100, and 150 μL injections.
A value that is below the detection limit for that
parameter on the ABG is denoted by a < followed by the
upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 6.944 | 39.4 | <30.1 | 4.2 | 11.0% | 87.2% |
| 1 | 50 | 7.631 | <15.4 | <30.1 | 4.0 | 13.9% | 83.6% |
| 2 | 50 | 7.694 | <15.4 | <30.1 | 4.1 | 12.2% | 85.9% |
| 3 | 50 | 7.716 | <15.4 | <30.1 | 4.1 | 12.5% | 85.3% |
| 4 | 100 | 7.698 | <15.4 | <30.1 | 4.0 | 20.8% | 76.7% |
| 5 | 100 | 7.704 | <15.4 | <30.1 | 4.1 | 17.3% | 80.2% |
| 6 | 100 | 7.716 | <15.4 | <30.1 | 4.1 | 15.1% | 82.7% |
| 7 | 150 | 7.645 | <15.4 | <30.1 | 3.9 | 20.2% | 76.7% |
| 8 | 150 | 7.67 | <15.4 | <30.1 | 3.9 | 13.3% | 84.5% |
| 9 | 150 | 7.673 | <15.4 | <30.1 | 3.8 | 16.6% | 80.8% |

TABLE 24
| Summary of ABG results following injection of
various volumes of nitrogenated aqueous solutions
of the highest concentration of silicalite-1 dispersion tested.
BL-1 corresponds to the baseline (pre-injection)
values for the blood before each of the 25 and 50 μL injections.
A value that is below the detection limit for
that parameter on the ABG is denoted by a < followed
by the upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 7.387 | 40.8 | <30.1 | 7.8 | 8.90% | 89.50% |
| 1 | 25 | 7.347 | 42 | <30.1 | 7.9 | 24.50% | 73.60% |
| 2 | 25 | 7.328 | 44.4 | <30.1 | 8.0 | 21.70% | 76.40% |
| 3 | 25 | 7.33 | 43.6 | <30.1 | 8.1 | 21.80% | 76.60% |
| 4 | 50 | 7.382 | 37.8 | <30.1 | 7.8 | 42.10% | 56.90% |
| 5 | 50 | 7.337 | 42.9 | <30.1 | 8.0 | 31.00% | 67.10% |
| 6 | 50 | 7.349 | 40.6 | <30.1 | 7.6 | 34.50% | 63.60% |

TABLE 25
| Summary of ABG results following injection of
various volumes of an oxygenated aqueous
solution of 5% (w/v) dextrose. BL-1 corresponds to the
baseline (pre-injection) values for the blood before
each of the 50, 100, and 150 μL injections. A value that is
below the detection limit for that parameter on the
ABG is denoted by a < followed by the upper bound of that value.

| | Injection | | pCO₂ | pO₂ | ctHb | | |
|---|---|---|---|---|---|---|---|
| Trial | vol (μL) | pH | (mmHg) | (mmHg) | (g/dL) | FO₂Hb | FHHb |
| BL-1 | 0 | 7.334 | 38.6 | <30.1 | 7.1 | 3.8% | 95.1% |
| 1 | 50 | 7.323 | 38.1 | <30.1 | 6.8 | 11.0% | 88.1% |
| 2 | 50 | 7.327 | 38 | <30.1 | 6.8 | 8.5% | 90.3% |
| 3 | 50 | 7.332 | 37.3 | <30.1 | 6.9 | 10.0% | 89.0% |
| 4 | 100 | 7.33 | 36.5 | <30.1 | 6.7 | 8.9% | 90.0% |
| 5 | 100 | 7.328 | 36.6 | <30.1 | 6.6 | 11.6% | 87.5% |
| 6 | 100 | 7.326 | 37 | <30.1 | 6.7 | 10.4% | 88.7% |
| 7 | 150 | 7.323 | 36.3 | <30.1 | 6.5 | 11.6% | 87.2% |
| 8 | 150 | 7.318 | 36.8 | <30.1 | 6.5 | 12.3% | 86.5% |
| 9 | 150 | 7.323 | 36.1 | <30.1 | 6.5 | 13.1% | 85.8% |

TABLE 26
Summary of the O₂ carrying capacities obtained for
each aqueous solution from the amount of O₂ released
to deoxygenated blood as a function of injection volume.

| | O₂ |
|---|---|
| | carrying |
| | capacity |
| Sample | (mL/dL) |
| 90 nm silicalite-1 (high-concentration) | 110 |
| 90 nm silicalite-1 (10.8 vol %) | 59.1 ± 2.7 |
| 60 nm silicalite-1 (9.1 vol %) | 50.5 ± 1.3 |
| (mPEG)ZIF-8 (6.6 vol %) | 16.2 ± 1.4 |
| 5% dextrose | 4.0 ± 1.4 |

TABLE 37
Calculation of the estimated pO₂ for three injections of 200 μL
of oxygenated aqueous solutions of 90-nm silicalite-1 nanocrystals
and comparison with the experimental pO₂ reported. Errors between
calculated and experimental values are given in parentheses. All
pressures are in mmHg.

| | | | (pO₂)_{c} |
|---|---|---|---|
| Trial | pO₂ | SO₂ | Severinghaus |
| 1 | 31.3 | 78.30% | 30.9 (1.23%) |
| 2 | 35.2 | 83.20% | 34.9 (0.80%) |
| 3 | 33.6 | 81.40% | 33.3 (0.83%) |

Other embodiments are in the claims.

What is claimed is:

1. A liquid composition comprising:
a) a polar liquid; and
b) a dispersion of porous particles, the pores of which comprise an internal surface that resists wetting by the polar liquid and an external surface that is wettable by the polar liquid, wherein the pores are sized to allow entry of a gas and molecules of the polar liquid.

2. The liquid composition of claim 1, wherein the internal surface is hydrophobic.

3. The liquid composition of claim 1, wherein the porous particles comprise a zeolite or metal-organic framework (MOF).

4. The liquid composition of claim 3, wherein the zeolite comprises silicalite-1, ZSM-5, or zeolite LTL or wherein the MOF comprises ZIF-8 or ZIF-67.

5. The liquid composition of any one of claims 1-4, wherein the particles are nanoparticles or microparticles.

6. The liquid composition of claim 5, wherein the particles are crystalline.

7. The liquid composition of claim 1, wherein the particles comprise a hydrophilic coating.

8. The liquid composition of claim 1, wherein the particles comprise a globular protein on the exterior.

9. The liquid composition of claim 8, wherein the globular protein is BSA, HSA, ovalbumin, or lactalbumin.

10. The liquid composition of claim 1, wherein the particles comprise a covalently or non-covalently attached hydrophilic organic polymer coating.

11. The liquid composition of claim 10, wherein the hydrophilic organic polymer coating is covalently attached to the particles by β-hydroxyalkyl covalent linkages.

12. The liquid composition of claim 1, further comprising the gas dissolved in the composition and located in the pores of the porous particles.

13. The liquid composition of claim 1, wherein the pores resist ingress of the polar liquid below an applied pressure of 100 bar at room temperature.

14. The liquid composition of claim 1, wherein the pores resist ingress of the polar liquid below an applied pressure of 200 bar at room temperature.

15. The liquid composition of claim 1, wherein the pores resist ingress of the polar liquid below an applied pressure of 900 bar at room temperature.

16. A composition comprising a plurality of microporous nanoparticles, the pores of which comprise an internal surface that resists wetting by a polar liquid and an external surface that is wettable by the polar liquid, wherein the pores are sized to allow entry of a gas and molecules of the polar liquid.

17. The composition of claim 16, wherein the porous particles comprise a zeolite or metal-organic framework.

18. The composition of claim 17, wherein the zeolite comprises silicalite-1 or ZSM-5 or zeolite LTL; or wherein the MOF comprises ZIF-8 or ZIF-67.

19. The composition of any one of claims 16-18, wherein the particles are nanoparticles or microparticles.

20. The composition of claim 19, wherein the particles are crystalline.

21. The composition of claim 16, wherein the particles comprise a hydrophilic coating.

22. The composition of claim 16, wherein the particles comprise a globular protein on the exterior.

23. The composition of claim 22, wherein the globular protein is BSA, HSA, ovalbumin, or lactalbumin.

24. The composition of claim 16, wherein the particles comprise a covalently or non-covalently attached hydrophilic organic polymer coating.

25. The composition of claim 7 wherein the hydrophilic organic polymer coating is covalently attached to the particles by β-hydroxyalkyl covalent linkages.

26. A method of storing a gas in a polar liquid, comprising:
providing a dispersion of porous particles in the polar liquid, wherein the pores of the particles comprise an internal surface that resists wetting by the polar liquid and an external surface that is wettable by the polar liquid, wherein the pores are sized to allow entry of the gas and molecules of the polar liquid; and
dissolving the gas in the dispersion, wherein the gas is stored in the pores.

27. The method of claim 26, wherein the internal surface is hydrophobic.

28. The method of claim 26, wherein the gas comprises argon, oxygen, nitrogen, carbon dioxide, carbon monoxide, xenon, methane, helium, neon, or hydrogen.

29. The method of claim 26, wherein the porous particles disintegrate after dissolution of the gas in the dispersion.

30. The method of any one of claims 26-29, wherein the porous particles are porous particles according to any one of claims 16-25.

31. A method of introducing a gas into a biological system, comprising:
providing a dispersion of porous particles in a polar liquid, wherein the pores of the particles comprise an internal surface that resists wetting by the polar liquid and an external surface that is wettable by the polar liquid, wherein the pores are sized to allow entry of the gas and molecules of polar the liquid; wherein the gas is stored in the pores; and
contacting the dispersion with the biological system.

32. The method of claim 31, wherein the porous particles are porous particles according to any one of claims 16-25.

33. A method of increasing the volumetric mass transfer of a gas to a substrate comprising:
providing a dispersion of porous particles in a polar liquid, wherein the pores of the particles comprise an internal surface that resists wetting by the polar liquid and an external surface that is wettable by the polar liquid, wherein the pores are sized to allow entry of the gas and molecules of the polar liquid; wherein the gas is stored in the pores; and
contacting the dispersion with the substrate and allowing the gas to react therewith.

34. The method of claim 33, wherein the porous particles are porous particles according to any one of claims 16-25.
